(19) United States
(12) Patent Application Publication
(10) Pub. No.: US 2024/0075146 A1
(43) Pub. Date: Mar. 7, 2024

(54) INTEGRATED LITHIUM TARGET

(71) Applicant: TAE TECHNOLOGIES, INC., Foothill Ranch, CA (US)

(72) Inventors: Michael P. Meekins, Silverado, CA (US); Alex Ho-Yin Cheung, Lynnwood, WA (US); Jon H. Schroeder, Foothill Ranch, CA (US)

(21) Appl. No.: 18/239,962

(22) Filed: Aug. 30, 2023

Related U.S. Application Data
(60) Provisional application No. 63/402,765, filed on Aug. 31, 2022.

(51) Int. Cl. A61K 41/00

(52) U.S. Cl. CPC A61K 41/0095

(57) ABSTRACT

The present disclosure provides an integrated target assembly containing a lithium layer attached to a base plate on a support structure made from a low-activation material. The support structure includes flow channels adjacent to the surface of the base plate for effective cooling of the base plate during operation. The integrated target assembly advantageously reduces the amount of easily activatable material, such as copper, leading to increased safety of the handling personnel.

### CROSS-REFERENCE TO RELATED APPLICATIONS

This application claims the benefit of the U.S. Provisional Patent Application No. 63/402,765 filed Aug. 31, 2022, which is incorporated herein by reference in its entirety.

### TECHNICAL FIELD

The subject matter described herein relates generally to a target assembly containing a lithium layer attached to a base plate (e.g., copper base plate) on a support structure made of a low-activation material (e.g., aluminum support structure) and containing fluid flow channels adjacent to the surface of the base plate for effective cooling of the base plate during operation.

### BACKGROUND

Cancer is one of the leading causes of death in contemporary society. The numbers of new cancer cases and deaths is increasing each year. Currently, cancer incidence is nearly 450 cases of cancer per 100,000 men and women per year, while cancer mortality is nearly 71 cancer deaths per 100,000 men and women per year. Locally invasive malignant tumors, such as brain cancer, cancers of head and neck, and cutaneous and extracutaneuous melanomas, are of particular concern as the effective means to treat or inhibit growth of those cancers is limited. For example, boron-neutron capture therapy, or BNCT, uses an accelerator-based neutron source to generate short-lived alpha-particles from boron-10 accumulated in the patients' tumor tissues. These alpha-particles selectively kill tumor cells while avoiding any damage to healthy organs and tissues.

### SUMMARY

The present disclosure provides, inter alia, a lithium-containing neutron generation target, useful to produce a beam of neutrons for bombarding a boron-containing compound in a boron-neutron capture therapy (“BNCT”) of cancer. The present disclosure is based, at least in part, on a realization that dissimilar materials can be bonded together, creating an integrated target design where the amount and mass of easily activatable material (such as copper and steel) is reduced, and the target performance is optimized by including fluid flow channels in a support structure made from low-activation material (such as aluminum). By minimizing the amount and type of activated material, the exposure to radioactive waste can be reduced, thereby keeping personnel safe when removing and handling the irradiated target assembly. Hence, the integrated target assembly of this disclosure provides safer target exchange and storage protocol when compared with targets made substantially from the easily activatable material. The integrated targets of this disclosure also lead to significant improvement in terms of waste storage by minimizing the amount of irradiated target material that goes into waste. The amount of heavy shielding cask (e.g., lead cask) required for transporting and storage of the radioactive target is also reduced. Finally, the integrated target design of this disclosure eliminates the need for stainless steel or other similar materials (such as steel bolts) for target mounting, further reducing the activated and stored nuclear waste and improving personnel safety.

Unless otherwise defined, all technical and scientific terms used herein have the same meaning as commonly understood by one of ordinary skill in the art to which the present application belongs. Methods and materials are described herein for use in the present application; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control. Other features and advantages of the present application will be apparent from the following detailed description and figures, and from the claims.

### DESCRIPTION OF DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is a schematic diagram of an example embodiment of a neutron beam system.

FIG. 1B is a schematic diagram of another example embodiment of a neutron beam system.

FIG. 2A is a top-side view of a vertical cross-section of an example of a neutron-generating target.

FIG. 2B is a side view of a vertical cross-section of an example of an assembly securing a neutron-generating target.

FIG. 3 is a top-side view of a horizontal cross-section of an example of a neutron generating target.

FIG. 4 is a side view of a vertical cross-section of an example of a neutron-generating target.

FIG. 5A is a top-side view of an example of a neutron-generating target.

FIG. 5B is another top-side view of an example of a neutron-generating target.

FIG. 6 is a top view of an example of a neutron-generating target.

FIG. 7A is a flow chart of an example of a process of making a combination of a substrate and a support structure for a neutron-generating target.

FIG. 7B is a block diagram of an example of association between a controller with computer instructions and a three-dimensional printer for making a combination of a substrate and a support structure.

FIG. 8A is a flow chart of an example of a process of making a neutron-generating target.

FIG. 8B is a block diagram of an example of association between a controller with computer instructions and a three-dimensional printer for making a neutron-generating target.

FIG. 9 is a flow-chart of an example of a process of treating cancer using a neutron-generating target.

### DETAILED DESCRIPTION

The lithium coupling embodiments described herein can be implemented in variety of applications where it is desired to couple or attach a lithium layer to a substrate, for example, by adhering the lithium layer to the substrate by mechanical forces. The lithium coupling embodiments can be used in both medical and non-medical applications. Suitable examples of non-medical applications include fusion reactors, scientific tools for nuclear physics research (e.g., Faraday cups to catch charged particles in a vacuum), industrial manufacturing processes, beam systems for the alteration of material properties (e.g., surface treatment and transmutation), beam systems for the irradiation of food, and non-medical imaging applications (e.g., cargo or container inspection). Suitable examples of medical applications include beam systems for pathogen destruction and medical sterilization, medical diagnostic systems, medical imaging systems, and radiation therapy systems (e.g., X-ray machines, Cobalt-60 machines, linear accelerators, proton beam machines, and neutron beam machines). One example of a medical application of the lithium coupling embodiments described herein is a neutron-generating target for boron neutron capture therapy (“BNCT”).

Generally, boron neutron capture therapy (“BNCT”) is a type of treatment of a variety of types of cancer, including the most difficult types. Suitable examples of such cancers include liver cancer (including liver metastases), oral cancer, colon cancer, brain cancer such as glioblastoma, head and neck cancer, lung cancer, extensive squamous cell carcinoma, laryngeal cancer, and melanoma. BNCT is a technique that selectively aims to treat tumor cells while sparing the normal cells using a chemical compound containing non-radioactive isotope boron-10, which has a high propensity to capture low energy “thermal” or “epithermal” neutrons. In this technique, a boron-containing compound is administered to a patient (e.g., by injecting a parenteral composition to a blood vessel of the patient), allowing boron-10 to selectively collect in tumor cells. Suitable examples of boron delivery agents that can be administered to the cancer patients include boronated amino acids, boron nitride nanotubes, liposome and immunoliposomes carrying particles of boron, various boron-containing nanoparticles, boronated cyclic or acyclic peptides having affinity to cancer cells (e.g., boronated arginylglycylaspartic acid, “RGD,” or a cyclic version thereof), boronated compounds having affinity to receptors overexpressed in cancer cells, boronated sugars, and boronic acid. Generally, these compounds are capable of selectively accumulating within malignant tumors while avoiding healthy tissues (e.g., at least about 85 wt. %, at least about 90 wt. %, at least about 95 wt. %, or at least about 99 wt. % of the boron compound accumulates in the tumor tissue as opposed to the healthy tissues). For example, upon administration of the boron carrier compound, tumor concentration of boron can be obtained in the range of about 20-50 μg ¹⁰B/g tumor.

The tumor concentration of boron can be determined by any means generally known to physicians for this purpose, such as imaging, calibration, and/or biopsy. Once a sufficient amount of boron-10 has collected within the tumor, the patient receives radiation in the form of a neutron beam at or near the tumor site.

Typically, to produce a neutron beam, a neutron generating material, such as lithium, is bombarded with protons of sufficient energy (e.g., energy above the Li⁷→Be⁷ reaction threshold of 1.88 MeV), whereby the protons are generated in an ion accelerator from a beam of negative hydrogen ions. The neutron-generating reaction may be described as follows, where p represents a proton and n represents a neutron:

Li⁷(3p,4n)+p=Be⁷(4p,3n)+n (eq. 1)

The resulting neutron beam is moderated and focused on the patient, where the neutrons react with the boron-10 in the tumor cells to generate a short-range alpha particle (He⁴) that selectively kills the tumor cells:

B¹⁰(5p,5n)+n=Li⁷(3p,4n)+He⁴(2p,2n) (eq. 2)

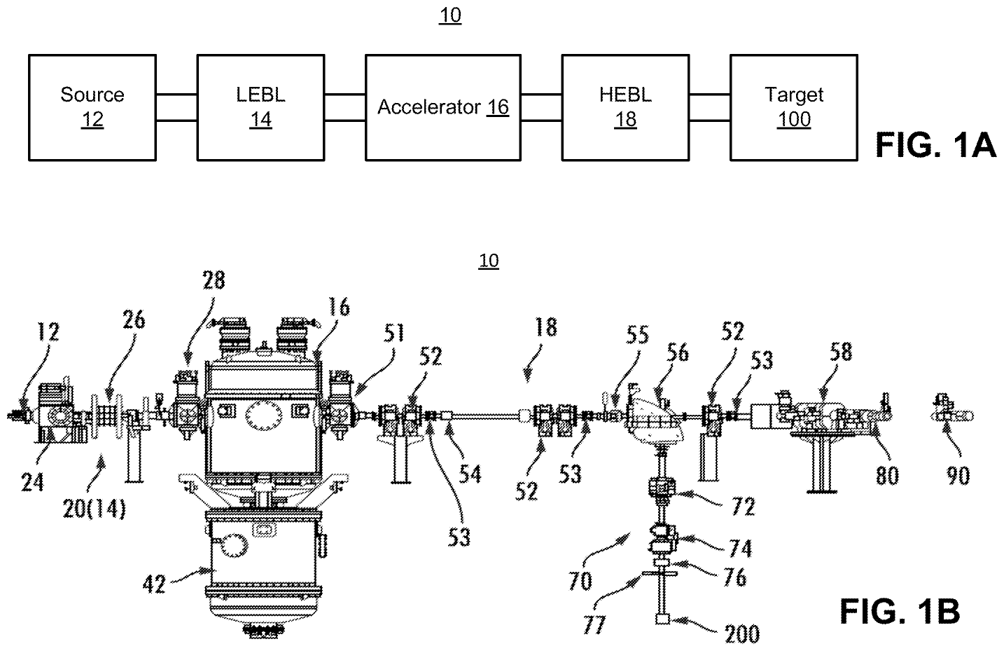

FIG. 1A contains a schematic diagram of an example of a neutron beam system 10, which can be used to generate the neutrons for BNCT using a lithium-containing neutron generation target of the instant disclosure (target 100).

In FIG. 1A, beam system 10 includes a source of hydrogen ions 12, a low-energy beamline (“LEBL”) 14, an accelerator 16 coupled to the LEBL 14, and a high-energy beamline (“HEBL”) 16 extending from the accelerator 16 to a target 100. LEBL 14 is configured to transport a negative hydrogen ion beam from the ion source 12 to an input of accelerator 16, which in turn is configured to produce a beam of protons by accelerating the beam of hydrogen ions transported by LEBL 14. HEBL 18 transfers the proton beam from an output of accelerator 16 to target 100. Upon bombardment by protons of sufficient energy, target 100 is configured to produce a beam of neutrons that is further directed to the tumor site in the patient body (not shown).

FIG. 1B is a schematic diagram illustrating another example embodiment of a neutron beam system 10 for use in boron neutron capture therapy (BNCT). Here, source 12 is an ion source and accelerator 16 is a tandem accelerator. Neutron beam system 10 includes a pre-accelerator system 20, serving as a charged particle beam injector, high voltage (HV) tandem accelerator 16 coupled to pre-accelerator system 20, and HEBL 18 extending from tandem accelerator 16 to a neutron target assembly 200 housing target 100 (not shown). Pre-accelerator system 20 is configured to transport the hydrogen ion beam from ion source 12 to the input (e.g., an input aperture) of tandem accelerator 16, and thus also acts as LEBL 14. Tandem accelerator 16, which is powered by a high voltage power supply 42 coupled thereto, can produce a proton beam with an energy generally equal to twice the voltage applied to the accelerating electrodes positioned within accelerator 16. The energy level of the proton beam can be achieved by accelerating the beam of negative hydrogen ions from the input of accelerator 16 to the innermost high-potential electrode, stripping two electrons from each ion, and then accelerating the resulting protons downstream by the same applied voltage.

HEBL 18 can transfer the proton beam from the output of accelerator 16 to the target 100 within the neutron target assembly 200 positioned at the end of a branch 70 of the beamline extending into a patient treatment room. System 10 can be configured to direct the proton beam to any number of one or more targets and associated treatment areas. In this embodiment, the HEBL 18 includes three branches 70, 80 and 90 that can extend into three different patient treatment rooms, where each branch can terminate in a target assembly 200 and downstream beam shaping apparatus (not shown). HEBL 18 can include a pump chamber 51, quadrupole magnets 52 and 72 to prevent de-focusing of the beam, dipole or bending magnets 56 and 58 to steer the beam into treatment rooms, beam correctors 53, diagnostics such as current monitors 54 and 76, a fast beam position monitor 55 section, and a scanning magnet 74.

The design of HEBL 18 depends on the configuration of the treatment facility (e.g., a single-story configuration of a treatment facility, a two-story configuration of a treatment facility, and the like). The proton beam can be delivered to target assembly 200 (e.g., positioned near a treatment room) with the use of bending magnet 56. Quadrupole magnets 72 can be included to then focus the proton beam to a certain size at the target. Then, the proton beam passes one or more scanning magnets 74, which provides lateral movement of the proton beam onto the target surface in a desired pattern (e.g., spiral, curved, stepped in rows and columns, combinations thereof, and others). The proton beam lateral movement can help achieve smooth and even time-averaged distribution of the proton beam on the lithium target 100, preventing overheating and making the neutron generation as uniform as possible within the lithium layer.

After entering scanning magnets 74, the proton beam can be delivered into a current monitor 76, which measures beam current. Target assembly 200 can be physically separated from the HEBL volume with a gate valve 77. The main function of the gate valve is separation of the vacuum volume of the beamline from the target while loading the target and/or exchanging a used target for a new one. In embodiments, the beam may not be bent by 90 degrees by a bending magnet 56, it rather goes straight to the right of FIG. 1B, then enters quadrupole magnets 52, which are located in the horizontal beamline. The beam could be subsequently bent by another bending magnet 58 to a needed angle, depending on the building and room configuration. Otherwise, bending magnet 58 could be replaced with a Y-shaped magnet in order to split the beamline into two directions for two different treatment rooms located on the same floor.

In one general aspect, the present disclosure provides a lithium-containing target useful in applications where various forms of radiation are required. One example of the lithium-containing target of this disclosure is a neutron-generating target, such as target 100 within the target assembly 200 (with reference to FIGS. 1A and 1B), useful to produce a beam of neutrons for bombarding a boron-containing compound administered to a patient during BNCT.

Generally, any target assembly has a finite lifetime and requires multiple replacements annually as the lithium turns into beryllium during the proton bombardment of lithium and the neutron generation reaction (see eq. 1 above). As a byproduct, the reaction typically produces a large amount of heat that needs to be removed during the target operation to avoid melting lithium. As such, the target is usually made from a highly thermally conductive material, such as copper, gold, or silver, to facilitate removal of heat from lithium. However, as another by-product of the nuclear reaction required to produce the neutrons, the highly thermally conductive material also becomes highly radioactive, emitting various gamma rays through a variety of nuclear decay processes that have lifetimes of several months. In the existing BNCT targets, due to the high pressure water required for effective target cooling, the part of the target that is made from the thermally conductive, radioactive material is thick and massive. The large amount of this material in the target ensures robustness necessary to support the differential water pressure, and to maintain all vacuum and water seals. In addition, the massive target is usually mounted within a holding device (which supports the target plate, provides hermetic sealing for the required water cooling and maintains vacuum). Within this device, the thick thermally conductive plate is clamped between several other thick plates (such as aluminum plates) with several high strength steel bolts to create the required seal and provide an interface with the inlet and outlet water. But when the target is made from a large amount of the easily activatable, radioactive material, the irradiated target prior to replacement is a significant radiological hazard. Because the targets are exchanged by hand and then stored in a deep hole in the basement of the facility, all interactions with the target (exchanging, transporting and storing) pose significant safety concerns and the radiation exposure of the personnel can be substantial. In some instances, the expected dose to personnel in close proximity to the target assembly, post irradiation, may exceed the allowable annual whole-body dose of 20 msV.

Accordingly, the present disclosure provides, inter alia, an integrated neutron-generation target assembly with substantially reduced size, mass, and amount of easily activatable material (e.g., copper, gold, steel) required for an efficient neutron target. The target within the present disclosure includes a thin thermoconductive plate integrated with a support structure made from low-activatable material (such as aluminum). The support structure, in turn, includes fluid flow channels adjacent to the thermoconductive plate for efficient water cooling. In addition, the integrated target of this disclosure can be supported within the holding device only at the outer diameter, such that it does not require clamping the target using heavy steel bolts to create water and/or vacuum seal. Because of this, the overall outer diameter of the integrated target can be smaller compared to currently used targets that are clamped by steel bolts between aluminum plates. As such, the integrated design of a target made from dissimilar materials (thermoconductive, easily activatable plate material integrated with low activation support material for water cooling) significantly reduces (and in fact minimizes) the materials that are more susceptible to radiation activation (such as copper and stainless steel). The targets of this disclosure, prepared by fusing high- and low-activatable materials, maintain all of their operational aspects (such as providing support for lithium in vacuum chamber and efficient water cooling to avoid lithium melting) and show optimized performance while having dramatically decreased size, mass, and residual radioactivity. The reduced mass and size of the targets promotes safety of the personnel handling the target replacement and transportation by reducing exposure to irradiation. In addition, the total amount of radioactive waste material going into storage is minimized, further reducing the amount and size of shielding casks required for the waste storage.

Example of Integrated Target of this Disclosure

Accordingly, in some embodiments, the present disclosure provides an article which includes the following components (i)-(iii):

(i) A first layer made from a material with high thermal conductivity. Generally, the first layer has a first surface and a second surface opposite the first surface.

(ii) A second layer made substantially from lithium. In some embodiments, the second layer is supported by the first surface of the first layer.

(iii) A support structure made from one or more materials different from the first layer. Generally, the support structure includes one or more hollow channels adjacent to the second surface of the first layer. In some embodiments, each of the one or more channels defines a continuous fluid path from a center to the second surface of the first layer to an edge of the first layer.

In some embodiments, the present disclosure also provides a combination including only components (i) and (iii) mentioned above. The combination can be used, for example, to prepare the article by attaching a layer (ii) of lithium to the first layer (i). In particular, this disclosure provides a combination including components (a) and (b):

(a) A first layer made from a material with high thermal conductivity. Generally, the first layer has a first surface and a second surface opposite the first surface.

(b) A support structure made from one or more materials different from the first layer. Generally, the support structure includes one or more hollow channels adjacent to the second surface of the first layer. In some embodiments, each of the one or more channels defines a continuous fluid path from a center to the second surface of the first layer to an edge of the first layer.

In some embodiments, the article is a neutron-generating target. Referring to FIGS. 1A and 1B, an example of the article is a target 100 within the target assembly 200. As such, the article may be useful to produce a beam of neutrons for bombarding a boron-containing compound administered to a patient during BNCT.

In some embodiments, the weight of the article is from about 20 g to about 1,000 g, from about 100 g to about 1,000 g, from about 200 g to about 800 g, from about 250 g to about 1,000 g, or from about 500 g to about 1,000 g.

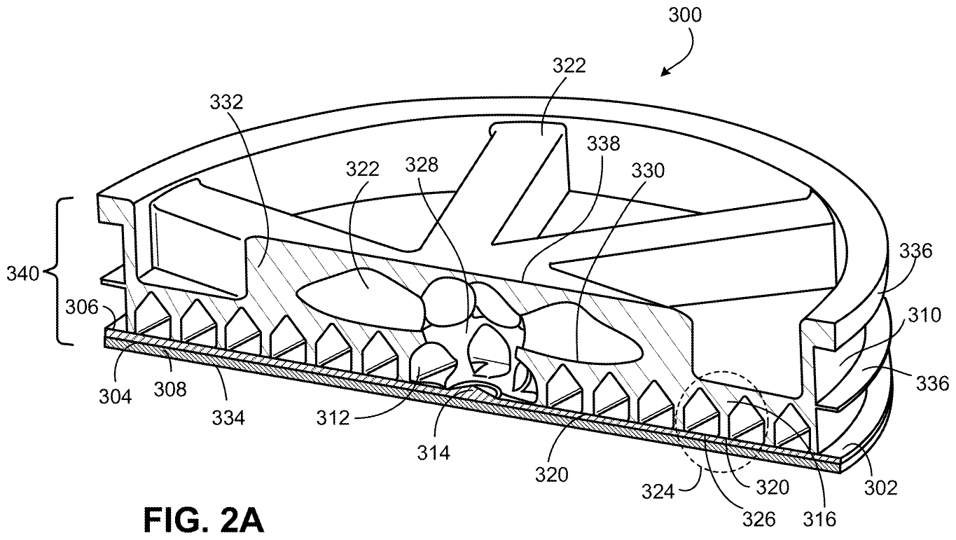

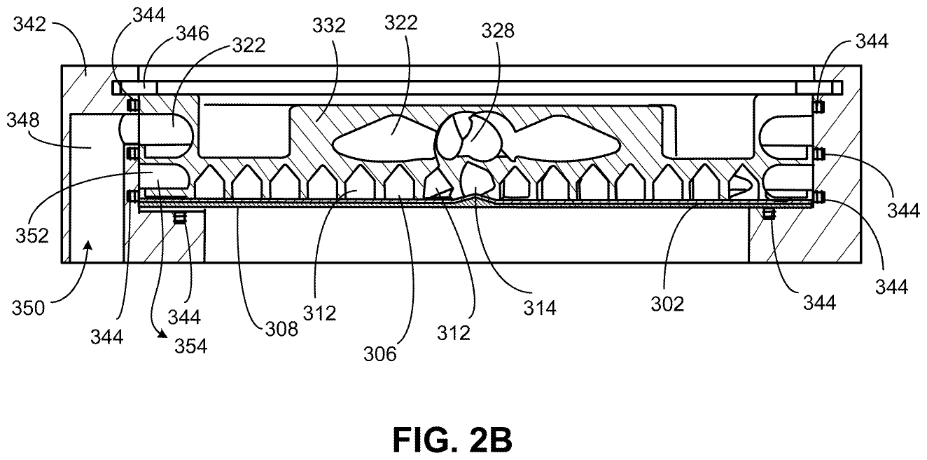

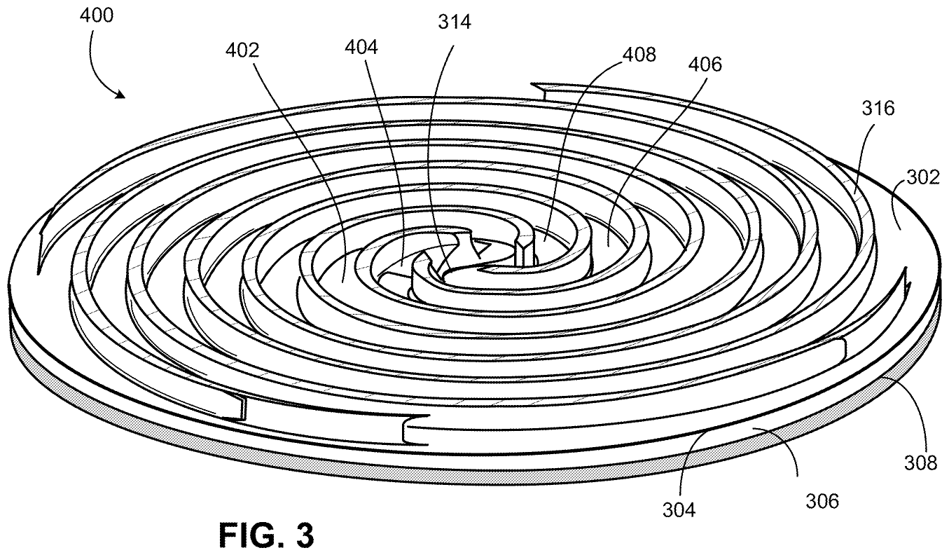

An example of the article 300 of this disclosure, in vertical cross-section, is shown in FIG. 2A. Referring to FIG. 2A, article 300 contains the first layer 302 having a first surface 304 and a second surface 306. The article 300 also includes a second layer 308 made substantially from lithium that is adjacent to and supported by the first surface 304 of the first layer 302. In some embodiments, being supported by the first surface 304 of the first layer 302 refers to the second layer 308 being bonded to (or adhered to) the first layer 302 through diffusion (or alloying) of lithium into the material of the first layer 302 (e.g., copper).

The article 300 also includes support structure 310. The support structure 310 contains hollow first channels 312 adjacent to the second surface 306 of the first layer 302, each first channel 312 defining a continuous path (e.g., fluid path) from the center 314 of the second surface 306 of the first layer 302 to the edge of the first layer 302. In some embodiments, the first layer 302 is supported by the support structure 310 at the sections of the support structure 310 that are adjacent to the first layer 302 (e.g., the first layer 302 is supported by the sections of the support structure 310 that are adjacent to the second surface 306). For example, the support structure 310 includes walls 316 separating the adjacent first channels 312 from one another. Examples of the thickness of the wall 316 include from about 0.1 millimeter (mm) to about 0.5 mm, from about 0.1 mm to about 1 mm, from about 1 mm to about 2 mm, from about 2 mm to about 3 mm, from about 3 mm to about 4 mm, or from about 4 mm to about 5 mm. In some embodiments, the wall 316 thickness is about 1 mm or less, about 2 mm or less, about 3 mm or less, about 4 mm or less, or about 5 mm or less. In some embodiments, the first layer 302 is supported at one or more sections (e.g., surfaces) 320 within the walls 316 that are adjacent to the first layer 302. In some embodiments, the first layer 302 being supported by the support structure 310 (e.g., at the one or more sections 320 of the walls 316 adjacent to the first layer 302) refers to the support structure 310 being bonded to (or adhered to) the first layer 302 (e.g., to the second surface 306 of the first layer). In one example, the support structure 310 may be bonded to the first layer 302 through diffusion (or alloying) of the material of the support structure 310 (e.g., aluminum) into the material of the first layer 302 (e.g., copper). In this example, the support structure 310 may by bonded to the first layer 302 by metallic bonds. Together, the support structure 310 adhered to and adjacent to the second surface 306 of the first layer 302 form a combination 340.

In some embodiments, the vertical cross-section of any first channel 312 is an intersection of a plane perpendicular to the second surface 306 of the first layer 302 and encompassing the center 314 of the second surface 306. This intersection may have any shape depending on the three-dimensional shape of the first channel 312. Examples of a vertical cross-section of the first channel 312 include a circle, an ellipse, a parabola, a hyperbola, a triangle, a rectangle, a square, a rhombus, a trapezoid, a pentagon, a hexagon, or any combination of the foregoing.

In one example, referring to FIG. 2A, the one or more first channels 312 may have a house-shaped cross-section 324. In this example, the cross-section 324 is a combination of a square and a triangle shapes, wherein square is the “house” part of the cross-section, and triangle is the “roof” part of the cross-section. In some embodiments, the foundation 326 of the “house” of the house-shaped cross-section 324 includes the second surface 306 of the first layer 302, while the triangular “roof” portion of the house-shaped cross-section 324 tapers to an apex 318 with increasing distance from the second surface 306 of the first layer 302.

In some embodiments, the height of a vertical cross-section of any first channel 312 (e.g., a distance between the second surface 306 and the apex 318 of the house-shaped cross-section 324) is from about 0.1 mm to about 0.5 mm, from about 0.1 mm to about 1 mm, from about 0.5 mm to about 1 mm, from about 1 mm to about 2 mm, from about 1 mm to about 5 mm, from about 1 mm to about 7 mm, from about 1 mm to about 10 mm, from about 2 mm to about 3 mm, from about 3 mm to about 4 mm, or from about 4 mm to about 5 mm. In some embodiments, the width of a vertical cross-section of any first channel 312 (e.g., width of the “house” part of the house-shaped cross-section 324) is from about 0.1 mm to about 1 mm, from about 0.1 mm to about 5 mm, from about 0.5 mm to about 1 mm, from about 1 mm to about 2 mm, from about 1 mm to about 5 mm, from about 1 mm to about 7 mm, from about 1 mm to about 10 mm, from about 2 mm to about 3 mm, from about 3 mm to about 4 mm, or from about 4 mm to about 5 mm. In some embodiments, thickness of the wall is about 1 mm, about 2 mm, about 3 mm, about 4 mm, or about 5 mm.

In some embodiments, the thickness of the wall 316 between any two adjacent first channels 312 may vary depending on the distance from the second surface 306 of the first layer 302. For example, in cross-section, the wall 316 between the two adjacent first channels 312 may resemble a funnel. In this example, the two adjacent channels 312 have a house-shaped cross-section, and the bottom of the neck of the funnel 320 is adjacent to (and also supports and is adhered to) the second surface 306 of the first layer 302. At the same time, the top of the funnel connects the apexes 318 of the two adjacent channels 312 and is distant from the second channel 322.

FIG. 3 shows a horizontal cross-section 400 of the article 300. Referring to FIG. 3, the cross-section 400 is a circular cross-section by a plane parallel to the second surface 306 of the first layer 302 at the half-height of a first channel 312. FIG. 3 shows an example of the article 300 containing four first channels 312. Each of these first channels 402, 404, 406, and 408 shown in FIG. 3 define a spiral path (e.g., continuous spiral fluid path) between the center 314 of the second surface and the edge of the first layer 302. Referring to FIG. 3, the first channels 402, 404, 406, and 408 are adjacent channels. More specifically, first channel 404 is adjacent to first channel 402, the first channel 402 is adjacent to the first channel 408, and the first channel 408 is adjacent to the first channel 406. Each pair to the two adjacent channels is separated by a wall 316 within the support structure 310 as described above with reference to FIG. 2A, and each of the adjacent channels defines a continuous spiral path (e.g., a fluid path) between the center of the second surface 314 and the edge of the first layer 302.

Referring to FIG. 2A, the support structure 310 also includes one or more second channels 322 distant from the second surface 306 of the first layer 302 and also distant from the first channels 312, where each second channel 322 defines a continuous fluid path from the edge (e.g., outer diameter) of the support structure 310 to the center 328 of the support structure 310. In some embodiments, the distance between the edge 318 of first channel 312 and the edge of the second channel 330 is from about 0.1 mm to about 0.5 mm, from about 0.1 mm to about 1 mm, or from about 1 mm to about 2 mm. In some embodiments, the distance between the second surface 306 of the first layer 302 and the edge 330 of a second channel 322 is from about 1 mm to about 20 mm, from about 1 mm to about 10 mm, from about 2 mm to about 15 mm, or from about 5 mm to about 15 mm. In some embodiments, the one or more first channels 312 and the one or more second channels 322 within the support structure 310 are fluidically connected between the center 328 and the center 314 of the second surface 306. For example, two or more second channels 322 may merge at the center 328 and form a continuous fluid path from the edge (e.g., outer diameter) of the support structure 310 through the center 314 and the one or more of the first fluid channels 312 to the edge of the first layer 302.

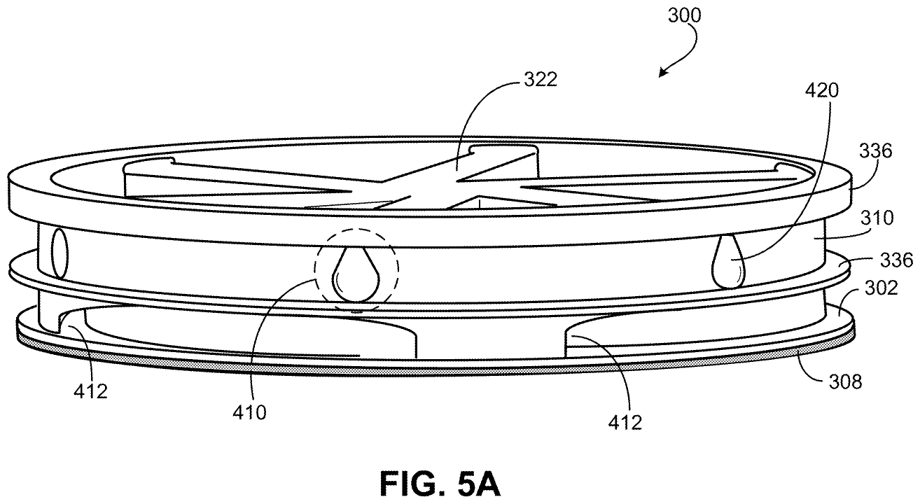

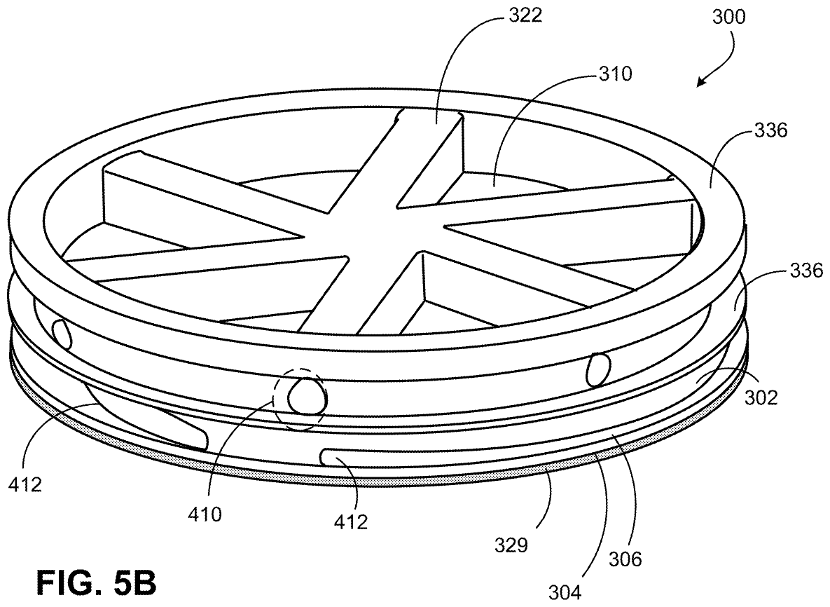

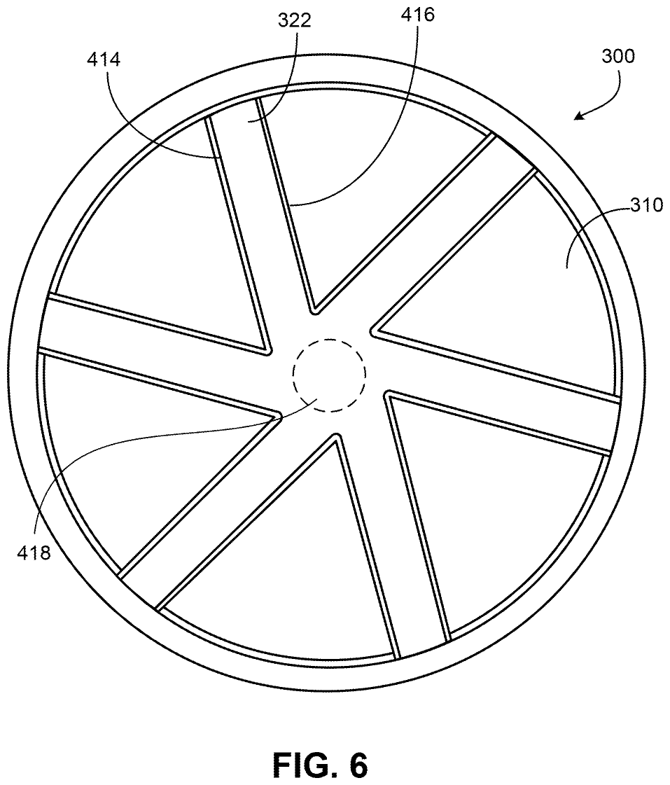

In some embodiments, the vertical cross-section of any second channel 322 is an intersection of a plane perpendicular to both the second surface 306 of the first layer 302 and the axis of the second channel 322 (such an axis may connect the edge of the support structure 310 and the center 328 and run parallel to all sides of the second channel 322). This intersection may have any shape depending on the three-dimensional shape of the second channel 322. Examples of a vertical cross-section of the second channel 322 include a circle, an ellipse, a parabola, a hyperbola, a triangle, a rectangle, a square, a rhombus, a trapezoid, a pentagon, a hexagon, or any combination of the foregoing. For example, the cross-section of the second channel 322 may have a tear-drop cross-section. In this example, the cross-section is a combination of a circle shape and a triangle shape, or a combination of a circle shape and a trapezoid shape (such as the cross-section 410 referring to FIG. 5A or 5B). In some embodiments, the height of the vertical cross-section of the second channel 322 is from about 1 mm to about 10 mm, from about 5 mm to about 10 mm, from about 2 mm to about 15 mm, or from about 5 mm to about 15 mm. In some embodiments, the height of the vertical cross-section of the second channel 322 is from about 1 mm to about 10 mm, from about 1 mm to about 7 mm, from about 2 mm to about 15 mm, or from about 5 mm to about 10 mm. In some embodiments, in case of a circular cross-section, the diameter of the cross-section of the second channel 322 is from about 1 mm to about 10 mm, from about 1 mm to about 7 mm, from about 2 mm to about 15 mm, or from about 5 mm to about 10 mm. In some embodiments, at least one of the second channel 322 has a wall 332 within the support structure 310. The thickness of the wall 332 may vary depending on the shape of the cross-section and the three-dimensional shape of the second channel 322. In some embodiments, the wall thickness may be from about 0.1 mm to about 0.5 mm, from about 0.1 mm to about 1 mm, from about 1 mm to about 2 mm, from about 2 mm to about 3 mm, or from about 2 mm to about 5 mm.

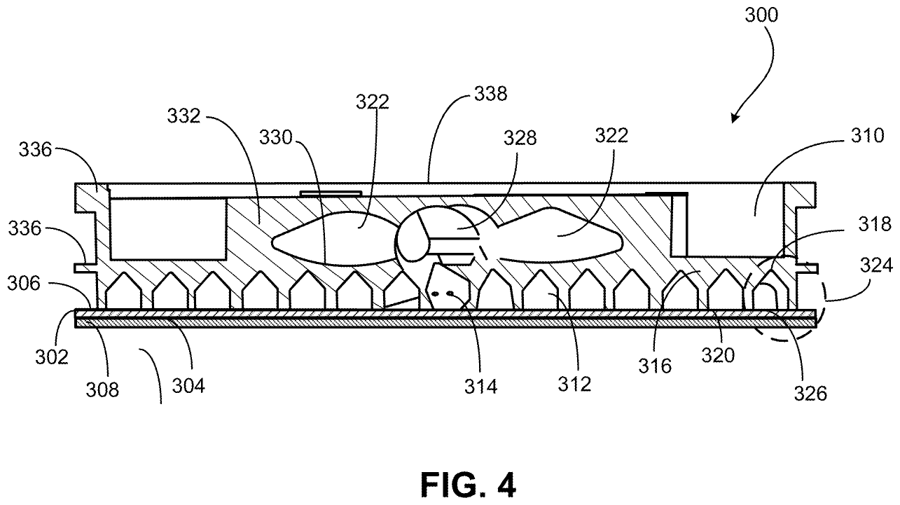

FIG. 4 shows a side view of a vertical cross-section of an example of article 300. Referring to FIG. 4, the lithium layer 308 is supported by the first surface 304 of the first layer 302. The second surface 306 of the first layer 302 is adjacent and attached to the support structure 310. The support structure 310 includes a plurality of first channels 312, each first channel having a house-shaped cross-section 324 including the apex 318 the foundation 326 (which includes the second surface 306 of the first layer 302).

FIGS. 5A and 5B are top-side views of an example of the article 300 of this disclosure. Referring to those figures, the lithium layer 308 is supported by the first surface 304 of the first layer 302, while the second surface 306 of the first layer 302 is adjacent to and supported by the support structure 310. FIG. 5B shows six symmetrically located second channels 322 within the support structure 310 that are distant from the second surface 306 of the first layer 302 (and distant from apexes 318 of the first channels 312, not shown). The second channels 322 have a tear-drop shaped vertical cross section (a combination of a circle and a trapezoid), each having a wall 332 (not shown) of various thickness depending on the distance from the axis of the second channel 322. FIGS. 5A and 5B also show the end 412 of a continuous path (e.g., fluid path) formed by a first channel 312 form the center 314 of the second surface 306 to the edge of the first layer 302. FIG. 6 shows a top view of an example of article 300 of this disclosure. The figure shows six rotationally symmetric second channels 322 within the support structure 310 and also shows outer edges 414 and 416 of the wall of the second channel 322. In some embodiments, the distance between the outer edges 414 and 416 is from about 5 mm to about 25 mm, from about 5 mm to about 20 mm, from about 5 mm to about 15 mm, or from about 5 mm to about 10 mm, or from about 10 mm to about 20 mm. FIG. 6 also shows a projection 418 of a cylindrical channel formed by the six second channels 322 merging at the center of the article 310. In one example, such a cylindrical channel provides a fluidic connection between the second channels 322 and the first channels 312 (not shown in FIG. 6), which allows for a flow of fluid from the edge of the support structure 310 (e.g., through a tear-shaped opening 420) to the edge of the first layer 302 (e.g., to the end 412 of the first channel 312).

Examples of the First Layer

In some embodiments, the first layer 302 (referring to FIG. 2B) may be referred to as a substrate of a target (e.g., a neutron-generating target) for applications where radiation of the target is required (such as BNCT). Generally, this substrate is configured for heat removal to dissipate the high energy level incident to irradiation, such as bombardment by a proton beam during neutron beam generation. For example, during proton bombardment of the lithium layer 308 in BNCT protons exit the second layer 308 relatively soon or immediately after the proton energy drops below the threshold of the Li⁷(p,n)Be⁷ reaction for neutron formation (e.g., the threshold of 1.88 MeV for lithium-7). Protons at about the threshold energy level (about 1.88 MeV for lithium-7) penetrate from layer 308 to substrate 302 and dissipate their remaining energy in the substrate 302 or partly in the substrate 302 and partly in the support structure 310. Because the support structure is made from a dissimilar material that is generally not easily activatable and less thermally conductive compared to layer 302, the substrate 302 is prepared form a material having a high thermal conductivity (e.g., the material that is a good conductor of heat) with a thickness that allows for deposition of substantially all residual protons in the substrate (e.g., allows to substantially avoid deposition of residual protons in the support structure 310).

In some embodiments, thermal conductivity of the substrate 302 is above 300 W×m⁻¹×K⁻¹, above 400 W×m⁻¹×K⁻¹, or above 500 W×m⁻¹×K⁻¹, or from about 300 W×m⁻¹×K⁻¹ to about 1200 W×m⁻¹×K⁻¹.

In some embodiments, thickness of the target substrate 302 may be from about 1 mm to about 12 mm, from about 2 mm to about 10 mm, or from about 1 mm to about 5 mm. In some embodiments, thickness of the layer 302 is about 1 mm, about 2 mm, about 3 mm, about 4 mm, about 5 mm, about 8 mm, or about 10 mm. In some embodiments, the substrate is about 2 times, about 5 times, about 10 times, about 20 times, about 50 times, about 60 times, about 70 times, about 80 times, about 90 times, or about 100 times thicker than the lithium layer 308.

In some embodiments, the first layer 302 may be prepared from any material known to have a high thermal conductivity, or a combination of such materials. Suitable examples of highly thermally conductive materials include metals such as copper (Cu), gold (Au), silver (Ag), or alloys of the aforementioned. Examples of highly thermally conductive alloys include tumbaga (alloy of gold and copper), sterling (alloy of copper and silver), and electrum (alloy of gold and silver). In some embodiments, the first layer 302 is made substantially from copper. For example, the first layer 302 contains about 90 weight percent (wt. %), about 95 wt. %, about 99 wt. %, or about 100 wt. % of copper. In some embodiments, the first layer is made from a material containing from about 95 wt. % to about 99 wt. % of copper. Other suitable examples of highly thermally conductive materials include beryllium oxide, diamond (e.g., CVD diamond), or metal- or metal oxide-diamond powder composites. In some embodiments, the highly thermally conductive layer 302 contains a copper-diamond powder composite.

Generally, the substrate 302 can be of any known shape and can be made to fit in the target assembly (e.g., target assembly 200 referring to FIG. 1B). Suitable examples of shapes for substrate 302 include a circle, a triangle, a rectangle, a square, a rhombus, a trapezoid, a pentagon, a hexagon, or any combination of the foregoing. In one example, the shape of the first layer 302 is the same as the shape of the article of this disclosure (e.g., the neutron-generating target 300). In this example, the first layer 302, the lithium layer 308, and the support structure 310 have substantially the same shape (e.g., a circle, a square, a rectangle, a pentagon, or a hexagon). In some embodiments, the target of this disclosure (including layers 302, 308, and 310) has a circular shape. The diameter of the circular article may be 5 centimeter (cm) or more, 7 cm or more, 10 cm or more, 15 cm or more, 20 cm or more, from about 5 cm to about 20 cm, form about 5 cm to about 15 cm, or from about 5 cm to about 10 cm. In another example, the first layer 302, the lithium layer 308, and the support structure 310 may have same or different shapes. In this example, first layer 302 may be a circle, layer 308 may be a circle of substantially same diameter as the first layer 308, and the support structure 310 may have a square or rhombus shape.

Examples of the Second Layer

The article of this disclosure may include a second layer made substantially from lithium. In one example, the second layer may include from about 90 wt. % to about 99 wt. % of lithium. In this example, the second layer contains about 90 wt. %, about 95 wt. %, or about 99 wt. % or more of lithium. Generally, the lithium layer is supported by a surface of the first layer (e.g., the lithium layer is adhered to the substrate layer). An example of the second layer of lithium is layer 308 in article 300 shown in FIG. 2B. The lithium in this layer may be a naturally occurring lithium composed of two stable isotopes, Li⁶ and Li⁷. An amount of Li⁷ isotope in the naturally occurring lithium material may range from about 90 wt. % to about 99 wt. %, or from about 92 wt. % to about 98 wt. %. In some embodiments, the lithium in the layer 308 is enriched in Li⁷ and depleted in Li⁶, such that the lithium material contains about 99.9 wt. % or about 100 wt. % of Li⁷. The lithium in layer 110 may also contain other isotopes of lithium, such as Li³, Li⁴, Li⁸, Li¹¹, or Li¹², or any combination thereof with the Li⁶ and/or Li⁷ isotopes.

A lithium layer 308 may be configured as a substantially planar neutron generation layer. FIG. 1A provides an example of using the lithium layer in a neutron-generation reaction. Referring to FIG. 1A, a proton beam propagating in direction B (e.g., from tandem accelerator 16 along HEBL 18) interacts with the layer 308 to produce neutrons that, in turn, pass through substrate 302 and exit downstream of target 300. The thickness of the lithium layer 302 (e.g., the distance between the outer surface 334 of the layer 308 and the first surface 304 of the substrate 302) can be selected depending on the energy of the protons propagating in the direction B. Table 1 illustrates the range (sometimes referred to as stopping range) of the incident proton particle in naturally abundant lithium (approx. 92% lithium-7) for several proton energies. In the right column the variable “depth-to threshold” is listed, and represents the distance which an average proton travels inside of the material before it slows down to the threshold energy for a ⁷Li(p,n)⁷Be reaction (about 1.88 MeV). After a proton is slowed past this threshold energy it can no longer produce neutrons. For instance, for a proton energy of 2.50 Mega electron-volts (MeV), the highly energetic proton enters the lithium material and then travels about 90 microns in lithium until it slows to the threshold energy. In this example, if the lithium thickness is less than 90 microns (μm), the neutron yield would be decreased and the lithium material is not utilized most efficiently. It is practically desirable to have a sufficiently thick lithium layer for the neutron-producing target, but not so thick (e.g., 200 μm for the 2.5 MeV proton energy) that reduction of the proton's energy below the threshold dissipates excessive heat in the lithium or produces undesirable gamma-radiation.

TABLE 1
Lithium Range in Natural Abundance (⁷Li, about 92 wt. %)

| | Range in | Depth to |
|---|---|---|
| Proton Energy (MeV) | Lithium (μm) | Threshold (μm) |
| 3.00 | 319.77 | 176.27 |
| 2.75 | 274.89 | 131.39 |
| 2.50 | 233.11 | 89.61 |
| 2.25 | 194.48 | 50.98 |
| 2.00 | 159.08 | 15.58 |
| 1.88 | 143.50 | 0.00 |
| 1.80 | 133.12 | NA |

In some embodiments, the thickness of the lithium layer 308 is from about 15 μm to about 180 μm, from about 20 μm to about 150 μm, from about 40 μm to about 120 μm, from about 80 μm to about 120 μm, or from about 90 μm to about 100 μm. In some embodiments, the proton energy is from about 2 MeV to about 3 MeV, or from about 2.25 MeV to about 2.75 MeV. In some embodiments, the proton energy is about 2.5 MeV and the thickness of the lithium layer on the substrate surface is about 90 μm or about 100 μm.

Generally, in the article of this disclosure, such as target 300, the lithium layer is supported by the first surface 304 of the first layer 302. In some embodiments, being supported by the first surface 304 refers to layer 308 being bonded to (or adhered to) the first layer 302. The bonding and adherence may occur through metallic bonds, electrostatic interactions, intermaterial diffusion, or any combination of the foregoing, between the lithium in layer 308 and the material of the first layer 302. For example, the desired support and bonding may be achieved during making of the article 300, as described more fully below.

In some embodiments, a protective covering (e.g., a passivation region) can be positioned over the lithium layer 308 (e.g., by applying the covering to the outer surface 334 of the lithium layer 308). Certain embodiments of the passivation materials, as well as their thickness and other characteristics, are described in U.S. application Ser. No. 17/711,298, which is incorporated herein by reference in its entirety.

Examples of the Support Structure

Generally, the support structure for the article of this disclosure is made such that the article (e.g., neutron-generating target) is sufficiently robust to perform under the harsh conditions during target irradiation. The support structure may contain elements, such as lips 336 (referring to FIG. 2A) to ensure that the target is securely affixed within the target assembly during operation. The thickness and other dimensions of the support structure are chosen to ensure that the structure is sturdy enough to withstand high pressure of the coolant fluid (e.g., water pressure) that flows through the support structure to cool off the substrate 302 and prevent melting of the lithium layer 308 during operation. In some embodiments, the thickness of the support structure (e.g., a distance between second surface 306 and the outer edge of the second channel 322) is from about 10 mm to about 25 mm, from about 10 mm to about 20 mm, or from about 10 mm to about 15 mm. At the same time, the support structure is also selected to minimize the use of highly-activatable materials and the overall weight of the target (as discussed above).

In some embodiments, the support structure may be made from a material having thermal conductivity lesser than the thermal conductivity of the material of substrate 302. For example, thermal conductivity of the material of the support structure is below about 400 W×m⁻¹×K⁻¹, below about 300 W×m⁻¹×K⁻¹ below about 200 W×m⁻¹×K⁻¹, or from about 50 W×m⁻¹×K⁻¹ to about 300 W×m⁻¹×K⁻¹. Without being bound by any particular theory or speculation, it is believed that the material of the support structure is low-activatable. In one example, the material of the support structure is less prone to residual radioactivity (e.g., gamma radioactivity) compared to the material of the substrate. Suitable examples of the materials of the support structure include aluminum (Al), titanium (Ti), magnesium (Mg), zinc (Zn), tungsten (W), nickel (Ni), cobalt (Co), vanadium (V), tin (Sn), or a similar light-weight metal, or an alloy of any of the foregoing. In some embodiments, density of the material of the support structure is from about 1 gram per cubic centimeter (g/cm³) to about 10 g/cm³, or from about 2 g/cm³ to about 5 g/cm³. In some embodiments, the support structure (such as the support structure 310) is made substantially from aluminum. For example, the support structure includes about 90 wt. %, about 95 wt. %, about 99 wt. %, or about 100 wt. % of aluminum. In some embodiments, the support structure is made substantially from titanium. For example, the support structure includes about 90 wt. %, about 95 wt. %, about 99 wt. %, or about 100 wt. % of titanium. In some embodiments, the support structure includes an alloy of aluminum and titanium. For example, the alloy contains about 50 wt. %, about 60 wt. %, about 70 wt. %, about 80 wt. %, or about 90 wt. % of aluminum, and about 50 wt. %, about 60 wt. %, about 70 wt. %, about 80 wt. %, or about 90 wt. % of titanium. The alloy may also include from about 1 wt. % to about 10 wt. % or from about 1 wt. % to about 5 wt. % of a metal selected from V, Mg, and W. In some embodiments, the support structure is substantially free from a material having thermal conductivity, such as Cu, Au, and Ag. In some embodiments, the support structure includes about 5 wt. % or less, about 4 wt. % or less, about 3 wt. % or less, about 2 wt. % or less, or about 1 wt. % or less of a thermally conductive, easily activatable material such as copper. In some embodiments, the support structure is made from a non-metal material. Suitable examples of such a material include carbon (C) (e.g., carbon nanotubes) and silicon (Si), as well as their oxides and nitrides, or any combination of the foregoing. The material of the support structure may be any carbon- or silicon-based material suitable for making a light but mechanically robust and sturdy structure usable in high temperature and high pressure conditions. For example, the material may be C, Si, SiO₂, SiO, SiC, Si₃N₄, or C₃N₄, or any combination thereof. In some embodiments, the material of the support structure is a composite material containing one or more metals and one or more non-metals. Suitable examples of such materials include aluminum-silicon composite (e.g., a material with the aluminum matrix impregnated with silicon carbide nanoparticles).

Methods of Making

The article (e.g., neutron-generating target) of this disclosure can be prepared by any method that is generally known in the art to adhere (or otherwise bond together) the two or more dissimilar materials. In one example, the article may be prepared by applying a layer of lithium to a combination of a substrate adhered to a support structure (as described above). Accordingly, the present disclosure provides methods of making the combination.

Making a Combination of Substrate on Support Structure

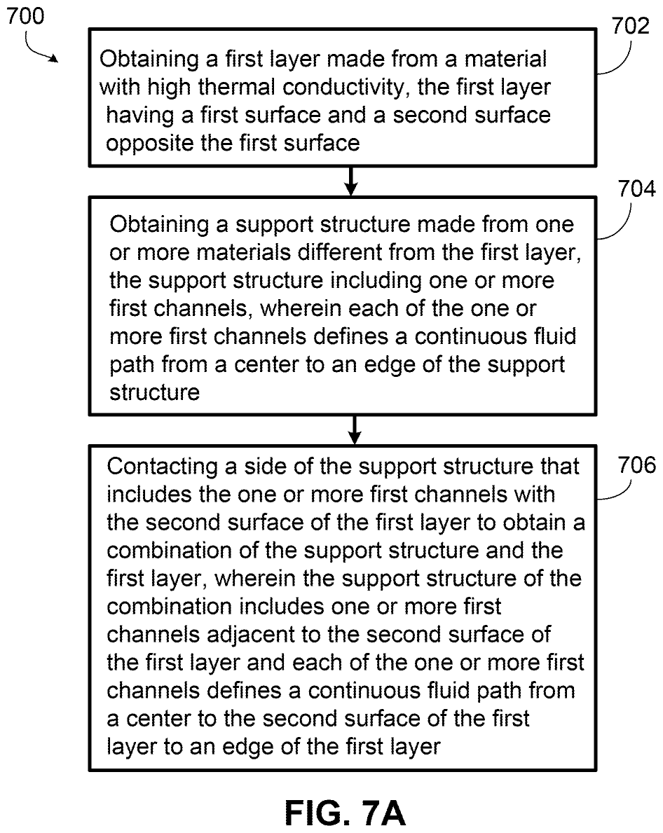

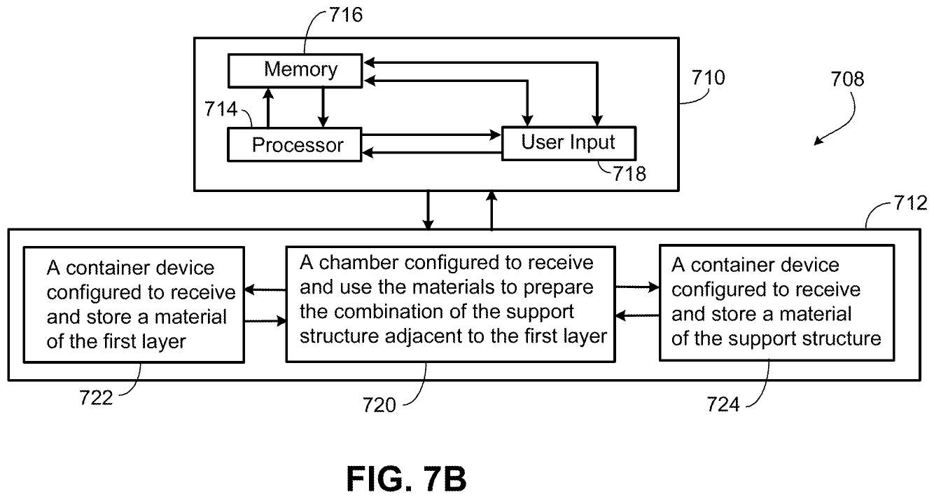

FIG. 7A provides a flow chart of a process 700 for making a combination of a support structure and a substrate (a first layer) supported by that structure (e.g., a combination 340 of layer 302 adhered to structure 310). Referring to FIG. 7A, the process 700 includes a step 702 of obtaining a first layer made from a material with high thermal conductivity, the first layer having a first surface and a second surface opposite the first surface. In some embodiments, the first layer obtained in step 702 is a substrate 302 as described above with reference to the FIGS. 2-5B. In one example, a target substrate 302 may be obtained by melting a suitable metal (e.g., copper) and then pouring the molten liquid metal into a mold having the shape of the desired target substrate, where it cools and solidifies thereby forming the substrate. In another example, the substrate may be obtained by stamping the solid material and then cutting it into the desired shape to obtain the substrate. The substrate may also be obtained using a three-dimensional printer configured to produce the substrate (e.g., as described below for using the 3D printer for making a combination).

The process 700 also includes a step 704 of obtaining a support structure made from one or more materials different from the first layer, the support structure including one or more first channels, wherein each of the one or more first channels defines a continuous fluid path from a center to an edge of the support structure. In some embodiments, the support structure obtained in step 704 is a support structure 310 as described above with reference to the FIGS. 2 and 4-6. The support structure in step 704 may be obtained in a manner that is similar to the processes of obtaining the first layer in step 702. More specifically, in one example, the support structure may be obtained by pouring a molten metal (e.g., aluminum) into a mold having the predetermined shape, including the second channels 322, lips 336, and walls 316 that form first channels 312 when bonded to the substrate layer 302. The metal is then allowed to solidify in the mold to form the support structure. In the alternative, the support structure may be obtained by converting a tablet-shaped (or puck-shaped) piece of material (e.g., aluminum) into the desired form. This may be accomplished for example, by drilling into the piece of metal to form one or more second channels 322, as well as cutting out the walls 316 and the remaining elements of the support structure. The support structure may also be obtained using a three-dimensional printer configured to produce the support structure from a corresponding starting material. Generally, steps 702 and 704 may be performed sequentially (e.g., step 702 may be carried out before or after step 704), or both steps 702 and 704 may be performed simultaneously.

Referring to FIG. 7A, the process 700 also includes a step 706 of contacting a side of the support structure that includes the one or more first channels (e.g., support structure obtained in step 704) with the second surface of the first layer (e.g., first layer obtained in step 702) to obtain a combination of a support structure with one or more first channels adjacent to the second surface of the first layer, wherein each of the one or more first channels defines a continuous fluid path from a center to the second surface of the first layer to an edge of the first layer. In some embodiments, during the contacting in step 706 the support structure and the first layer become adhered to (e.g., bonded to) each other, such that the first layer is supported uniformly (e.g., evenly) across the support structure. Without being bound by any particular theory or speculation, it is believed that the uniform support provided for the material of the first payer (e.g., copper substrate) by the support structure allows to decrease the overall thickness and mass of the target, leading to the advantages described above, e.g., the decreased exposure of personnel to residual radioactivity. The uniform support to the substrate also allows not to disrupt the flow and direction of the beam of neutrons, for example, when the target is used for neutron generation. The first layer and the support structure can be adhered to one another by any method generally known to reliably bond two dissimilar materials. Depending on the materials used to prepare the substrate and the support structure, these two elements may be bonded through metallic bonds, electrostatic interactions, intermaterial diffusion, or any combination of the foregoing. In some embodiments, the contacting step 706 may be carried out using brazing, welding, soldering, or by applying a mechanical force to either the first layer, the support structure, or both structural elements at the same time (e.g., during hot isostatic pressing). The mechanical force may range from about 1 megaPascal (MPa) to about 3 MPa. For example, the mechanical force is about 1 MPa, about 1.5 MPa, about 2 MPa, about 2.5 MPa, or about 3 MPa. In some embodiments, the mechanical force is less than or about the compressive stresses of the material of the first layer. In some embodiments, the mechanical force is less than or about the compressive stresses of the material of the support structure. In one example, either the material of the first layer, or the support structure, or both, can be heated to facilitate the bonding. For example, to facilitate adhesion in step 706, either the first layer or the support structure, or both, can be heated during the contacting to a temperature from about 400 degrees Celsius (° C.) to about 1000° C., or from about 400° C. to about 700° C. The elements may be heated, for example during brazing and soldering, and also during pressing the elements together by mechanical force. A skilled mechanical engineer would be able to select an appropriate device to carry out the contacting step to ensure bonding between the different materials. For example, if the first layer and the support structure are bonding by soldering, a soldering iron or a hot air gun may be used. In another example, if a mechanical force is applied to either the first layer or the support structure, a hydraulic press or a hot isostatic pressing vessel may be used to apply the force and ensure bonding. These operations may be performed using the same tool or a piece of machinery. For example, a single instrument or a piece of equipment may be configured to facilitate initial contacting between the first layer and the support structure, and also to apply heat and pressure to these elements, as may be required. An example of such an instrument may be a mechanical press equipped with a robotic arm. These operations may also be performed using separate pieces of equipment. In another example, the contact between the first layer and the support structure may be initiated by hand or using an automated robotic arm, followed by using a mechanical press to bond the two elements to obtain the combination of step 706.

A combination of the substrate adhered to the support structure may also be prepared using additive manufacturing method. Accordingly, the present disclosure provides a system for making the combination (e.g., combination 340 of support structure 310 and first layer 302), which in some embodiments include:

(i) A three-dimensional printer device configured to receive and store (a) the material with high thermal conductivity for making a first layer and (b) the one or more materials different from the material of the first layer for making a support structure. Exemplary embodiments of these materials are described hereinabove. In some embodiments, the three-dimensional printer device is also configured to prepare the combination of the support structure and the first layer. A skilled engineer would be able to select and implement an appropriate printer device. For example, a printer device using a fused deposition modeling, stereolithography, digital light processing, selective laser sintering, selective laser melting, laminated object manufacturing, digital beam melting, or any combination of the foregoing, can be implemented.

(ii) A controller associated with the three-dimensional printer device (i) including a processor, a memory; and computer instruction stored in the memory and executable by the processor. In some embodiments, the controller is configured to instruct the three-dimensional printer to prepare the combination from the corresponding materials (a) and (b). The controller may be a standard personal computer, or the controller may be specifically assembled to be associated with and to operate the three-dimensional printer device. In one example, the controller and the printer device are located within a single piece of equipment. Alternatively, the controller and the printer can be separate pieces of equipment that are electronically connected (e.g., by a cable or cables).

FIG. 7B generally shows an example of association 708 between controller 710 and the three-dimensional printer device 712. Referring to FIG. 7B, an example of the three-dimensional printer device 712 includes a container 722 with a material with high thermal conductivity for making the substrate of the combination. The container 722 is configured to receive, store, and provide the material to a chamber 720 where the first layer alone or the first layer within the combination are formed. The example of the three-dimensional printer device 712 also includes a container 724 with one or more materials of the support structure. The container 724 is configured to receive, store, and provide these material or materials to the chamber 720 for making the support structure alone or the support structure within the combination. The chamber 720 is configured to receive the materials from the containers 722 and 724, and to use these materials for making the combination of the support structure adjacent to and supporting the first layer (as described herein) upon receipt of instructions from processor 714 within the controller 710. Referring to FIG. 7B, the controller 710 includes processor 714, memory 716, and user input 718. All of the components of the controller 710, including processor, memory, and user input, are typically powered and connected electronically, for example, using a circuit board (mother board). In some embodiments, the memory 716 includes the necessary computer instructions to prepare the combination. Generally, the computer instructions are communicated from the memory 716 to the processor 714 for execution. The processor 714 is configured to instruct the three-dimensional printer 712 to prepare the substrate, the support structure, or the combination. User input 718 is connected to the memory 716 and the processor 714 and allows a user to influence the computer instructions, for example, by providing an algorithm (e.g., software with an algorithm) for making the support structure, the substrate layer, or the combination. For example, the algorithm may describe the making of the support structure 310 containing the first channels 312 and the second channels 322, including the fluidic connection between them, as well as the remaining features of support structure 310, such as lips 336, each feature having the desired dimensions (e.g., height, length, depth, and/or width) and related parameters. The algorithm may also include instructing the printer to prepare the combination of the support structure adjacent to the substrate by material transitioning. For example, the algorithm may include making about 99 wt. % of the first layer 302 from the material with high thermal conductivity, followed by making the remaining 1 wt. % of the first layer and the first 1 wt. % of the support structure form a mixture of the material of the first layer and the material of the support structure, to ensure that the first layer is adhered to the support structure. This is followed by making the remaining 99 wt. % of the support structure from the corresponding material to complete the combination. In one example, the mixture can include about 1 wt. %, about 10 wt. %, about 20 wt. %, about 40 wt. %, about 50 wt. %, about 60 wt. %, about 80 wt. %, about 90 wt. %, or about 99 wt. % of the material with high thermal conductivity. In another example, the mixture represents a gradient from 99 wt. % to 1 wt. % of the material with high thermal conductivity. The processor 714 carries out the necessary calculations, including the amounts of the materials that are needed at any point of time by the printer device to produce the substrate, the support structure, or the combination.

In some embodiments, the material stored and used in container 722 is any one of the materials of the first layer (e.g., first layer 302) as described above. One example of such a material is copper. In a similar manner, the material stored and used in container 724 is any one of the materials of the support structure (e.g., support structure 310) as described above. One example of such a material is aluminum. The material can be stored in container 722 or container 724 in any form that is suitable for using in three-dimensional printing. For example, the material in container 722 or container 724 can be stored in a solid or a liquid form. One example of the solid form include a particulate composition. For example, the material in container 722 or container 724 can be in a form of particles having a mean diameter from about 0.1 micrometer (μm) to about 10 μm or from about 1 μm to about 5 μm. The container 722 or container 724 may be heated as needed, for example, to a temperature from about 100° C. to about 300° C. or from about 150° C. to about 250° C.

Making Three-Layered Article

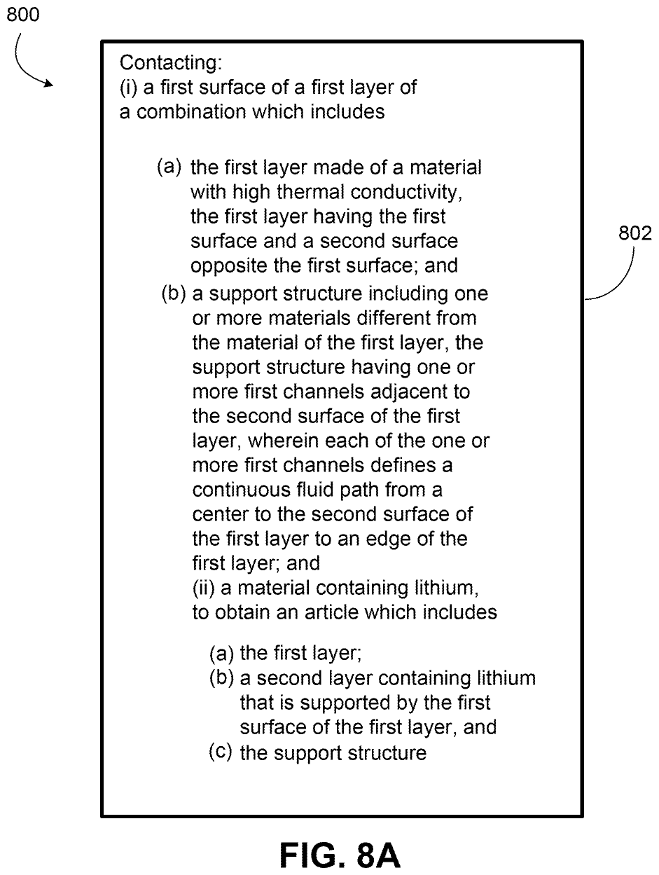

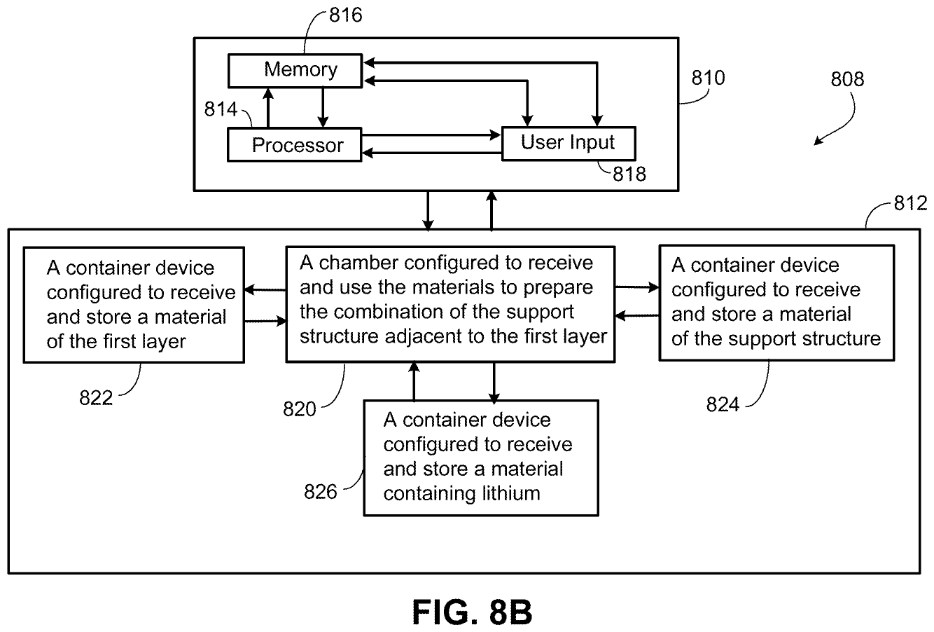

An example of a process 800 to prepare the article of this disclosure (e.g., the article 300 as described above) is provided in FIG. 8A. Referring to FIG. 8A, the process 800 includes a step 802 of contacting the first surface of the first layer in the combination obtained as described above (e.g., by three-dimensional printing or by pressing the support structure into the substrate to facilitate material diffusion) with a material containing lithium to obtain the article as described above (e.g., a neutron-generating target 300), containing the first layer, the second layer containing lithium supported by the first surface of the first layer, and the support structure with one or more first channels adjacent to the second surface of the first layer. In one example, the material containing lithium is any one of the materials of the second layer (e.g., layer 308) as described above. In this example, the material containing lithium in step 802 contains from about 95 wt. % to about 99 wt. % of lithium. Without being bound by any theory or speculation, it is believed that during the contacting in step 802 the material containing lithium becomes adhered to (e.g., bonded to) the first layer to form a second layer of lithium (e.g., layer 308 in article 300), such that the second layer is supported by the first surface of the first layer. In one example, the first surface of the first layer can be contacted with lithium to form the second layer by a vacuum deposition technique. In this example, the first surface of the first layer can be exposed to vacuum in a chamber of a vacuum evaporator. The lithium may then be evaporated under vacuum at a temperature from about 200° C. to about 500° C., or from about 300° C. to about 400° C., and then supplied to the vacuum chamber for condensation and deposition on the first surface of the first layer to form the second layer of the desired thickness. In another example, the contacting in step 802 may include applying a lithium foil of the desired thickness to the first surface of the first layer, followed by applying a mechanical force to the lithium foil to obtain the second layer supported by (e.g., adhered or bonded to) the first surface of the first layer. In this example, a thin intermediate layer may be applied to the first surface of the first layer to facilitate adhesion of lithium foil to (and subsequently support of the second layer by) the first surface of the first layer. Suitable examples of materials of the intermediate layer include metals (such as Li, Al, Ag, Au, Zn, Bi, Pd, Cr, Ti, Mo, V, and Ta, or a combination of the foregoing), non-metals (such as Si, SiO₂, SiO, Si, Si₃N₄, C₃N₄, and other silicon and carbon-based materials suitable for coating a surface), and metal derivatives (such as TiNSi, TiN, LiF, CrLiO₂, CrLi₂O₄, and CrLi₂O₂, or similar salts, oxides, and nitrides). The methods to adhere a lithium foil to a surface of a substrate, including methods using an intermediate layer, are described, for example, in U.S. provisional application No. 63/343,924, which is incorporated herein by reference in its entirety.

Another example of making the article 300 includes a system which includes a controller associated with a three-dimensional printer device. An example of the three-dimensional printer device include a printer that is configured to receive and store (a) a material with high thermal conductivity for making a first layer, (b) one or more materials different from the material of the first layer for making a support structure, and (c) a material containing lithium for making a second layer. Exemplary embodiments of all of these materials are described hereinabove. The three-dimensional printer is also configured to prepare the article of this disclosure, including the substrate layer supported by a support structure and a lithium layer supported by the substrate. Generally, a three-dimensional printer device as described herein for making the combination is also useful to prepare the three-layered article.

An example of a system for making the article 300 is schematically shown in FIG. 8B. Referring to FIG. 8B, a controller 810 (including a memory 816, a processor 814, and user input 818) is associated with a three-dimensional printer device 812. In some embodiments, the controller 810, the memory 816, the processor 814, and user input 818 are as described herein for controller 710, memory 716, processor 714, and user input 718, respectively, with reference to FIG. 7B. In some embodiments, the computer instructions stored in the memory 816 and influenced by the user through user input 818 include making the article 300 from the corresponding materials (e.g., the computer instructions include an algorithm for making the article from the corresponding materials). The three-dimensional printer 812 includes a container for the material of the first layer 822, a container for the material of support structure 824, a container for lithium 826, and a chamber 820 configured to make the article. In some embodiments, the containers 822 and 824 and chamber 820 are as described herein for container 722 and 724 and chamber 720, respectively, with reference to FIG. 7B. The container 826 is configured to receive, store, and provide a material containing lithium to a chamber 820 where the second layer alone or the second layer attached to substrate are formed. The lithium material can be stored in container 826 in any form that is suitable for using in three-dimensional printing, including a solid or a liquid form. The container can be cooled or heated as needed, for example, to a temperature from about 0° C. to about 150° C. The temperature may be above or below the melting point of lithium, as needed for making the second layer on the surface of the first layer in the three-dimensional printing process of making the article. The chamber 820 is configured to receive the materials from the containers 822, 824, and 826, and to use these materials for making the article (e.g., target 300) upon receipt of instructions from processor 814.

Methods of Use

In one example, the present disclosure provides methods of using the lithium-containing target of this disclosure (e.g., article 300) in BNCT to treat cancer. More specifically, the target may be included in a neutron beam system, such as the system 100 shown schematically in FIGS. 1A and 1B. The target may be included in the target assembly system 200, for example, for producing a beam of neutrons from the beam of protons. In some embodiments, the disclosure provides a method of treating cancer, e.g., in a subject in need thereof. Prior to treatment, the subject may be diagnosed with cancer by a treating physician. The physician may use any diagnostic tool generally known in the medical industry to diagnose cancer, such as biopsy. Suitable examples of cancer include liver cancer (hepatocellular carcinoma, intrahepatic cholangiocarcinoma, hepatoblastoma, or hepatic adenoma), oral cancer, colon cancer, brain cancer (e.g., glioblastoma, meningioma, or medulloblastoma), head and neck cancer, lung cancer, breast cancer, gastric cancer, extensive squamous cell carcinoma, laryngeal cancer, melanoma, sarcoma, and extramammary Paget's disease. The cancer includes recurrent cancer, pediatric cancer, and metastatic cancers.

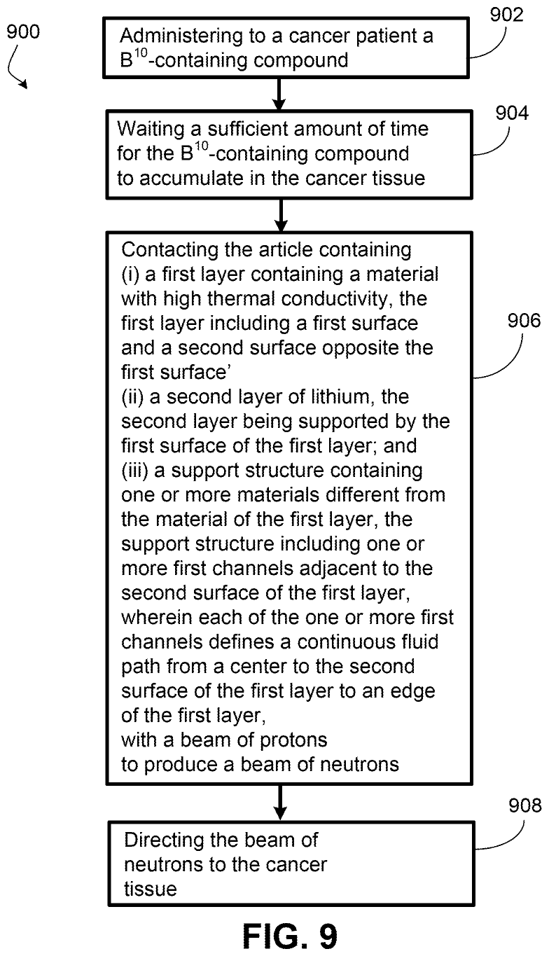

An example of a method 900 to treat cancer in a patient is provided with reference to FIG. 9. Referring to FIG. 9, the method 900 of treating cancer includes a step 902 of administering to the subject a therapeutically effective amount of a compound containing B¹⁰. Generally, the selected B¹⁰-containing compound has low systemic toxicity, rapid clearance from blood and normal tissues, high tumor uptake, and low normal tissue uptake. For example, the ratio of amount of B¹⁰ in tumor tissue to the amount of B¹⁰ in normal tissue after administration of the B¹⁰-compound is from about 2:1 to about 5:1 or from about 3:1 to about 4:1. In some embodiments, the therapeutic amount of the B¹⁰ compound is from about 1-100 mg of B l° for 1 kilogram (kg) of the subject's body weight. For example, the therapeutic amount of the B¹⁰-containing compound is from about 5 mg B¹⁰/kg to about 100 mg B¹⁰/kg, from about 5 mg B¹⁰/kg to about 80 mg B¹⁰/kg, or from about 5 mg B¹⁰/kg to about 40 mg B¹⁰/kg. The B¹⁰-containing compound can be administered to the subject in a pharmaceutical composition or a dosage form along with one or more pharmaceutically acceptable excipients. Suitable examples of such excipients include alumina, phosphate salts, colloidal silica, polyacrylates, polyethyleneglycol based polymers, and cellulose-based substances. The B¹⁰-containing compound can be administered to the subject by any suitable route of administration. For example, the compound may be administered orally, intradermally, or by intramuscular or intraperitoneal route. Examples of formulations and dosage forms for administering the B¹⁰ compound include tablets, capsules, and injectable solutions. Suitable examples of B¹⁰ compounds that can be administered to the subject include boronated derivatives of natural and unnatural amino acids, polyamines, peptides, proteins, antibodies, nucleosides, sugars, porphyrins, as well as the liposomes and nanoparticles. For example, the B¹⁰-containing compound is a boronated derivative of an amino acid such as aspartic acid, tyrosine, cysteine, methionine, or serine. In some embodiments, the B¹⁰-containing compound is boronophenylalanine, borocaptate sodium, or 1-amino-3-boronocyclo-pentanecarboxylic acid.

Referring to FIG. 9, the method 900 also includes a step of waiting a sufficient amount of time for the B¹⁰-containing compound to accumulate in the cancer tissue. The amount of waiting time may range from about 10 seconds (sec) to about 2 hours (h), from about 30 sec to about 1 h, or from about 1 min to about 30 minutes (min). In one example, the B¹⁰-containing compound may accumulate in the cancer tissue at a level from about 20 to about 50 microgram (μg) of B¹⁰ per gram (g) of tumor. The sufficient accumulation of B¹⁰ in the tumor can be determined, e.g., by a treating physician by any suitable technique. In one example, the level of B¹⁰ in the tumor can be determined using biopsy and elemental analysis of the tumor tissue. In another example, the level of B¹⁰ in the tumor tissue can be determined using imaging (e.g., fluorescent imaging, PET, X-ray, CT, or MRI).

The method 900 also includes a step 906 of contacting the article of this disclosure (e.g., the neutron-generating target 300 as described above) with a beam of protons of appropriate energy to produce a beam of neutrons. In some embodiments, the proton energy is from about 2 MeV to about 3 MeV, from about 2.2.5 MeV to about 2.75 MeV, or about 2.5 MeV. The method also includes a step 908 of directing the beam of neutrons to the cancer tissue. The steps 906 and 908 can be performed as described above with reference to FIGS. 1A and 1B. In some embodiments, during the operation of the target (e.g., in step 906), it is kept at its operating temperature from about 130° C. to about 150° C. or from about 140° C. to about 150° C. For example, the target may be cooled by a flow of a coolant fluid through the target.

For example, with reference to FIG. 2B, the target 300 is secured in the assembly 342 using a retaining ring 346 and O-rings 344. The coolant fluid may flow through in-flow channel 348 (in the direction 350), entering the target 300 through an opening 420 (referring to FIG. 5A), then flowing to the center of the support structure 328 through the second channel or channels 322. The coolant fluid then flows toward the center 314 of the second surface 306 of the first layer through a cylindrical channel between the centers 328 and 314 that forms a fluidic connection between the second channels 322 and the first channels 312. Upon reaching the second surface 306, the coolant fluid may flow from the center 314 and through the first channel or channels 312 to the edge of the first layer 302 to exit the target through the out-flow channel 352 in the direction 354. While flowing through the first channels, the coolant fluid remains in continuous contact with the second surface 306 of the first layer 302 thereby cooling the first layer 302 to its operating temperature. Suitable examples of coolant fluid include water, alcohol (e.g., methanol, ethanol, or isopropanol), and antifreeze, or a mixture thereof. The coolant fluid may be selected such that the boiling point of the coolant fluid is from about 50° C. to about 150° C. In some embodiments, the coolant fluid is water. In some embodiments, the coolant fluid for cooling the target is substantially degassed. For example, the coolant fluid contains less than about 1 wt. %, less than about 0.5 wt. %, or less than about 0.1 wt. % of dissolved gas (e.g., air or nitrogen). In some embodiments, the coolant fluid is substantially free from dissolved solid materials, such as inorganic salts (e.g., NaCl, MgSO₄ and the like). For example, the coolant fluid contains less than about 0.5 wt. %, less than about 0.2 wt. %, or less than about 0.1 wt. %, of the dissolved solids. In some embodiments, the coolant fluid flows through the target at a rate from about 10 kilogram per minute (kg/min) to about 200 kg/min, from about 30 kg/min to about 150 kg/min, from about 50 kg/min to about 100 kg/min, about 60 kg/min, about 70 kg/min, or about 80 kg/min. In some embodiments, the flow of the coolant fluid is a laminar flow. For example, the coolant fluid maintains laminar flow in the channels 322 as well as in the first channels 312 when in continuous contact with the first layer 302. Suitable examples of Reynolds number for the laminar flow of the coolant fluid is from about 1 to about 1,500, from about 10 to about 1,000, or from about 100 to about 500. In some embodiments, the inlet temperature of the coolant fluid (e.g., at the opening 420 of the support structure 310) is from about 5° C. to about 30° C., from about 10° C. to about 25° C., about 15° C., or about 20° C. In some embodiments, the outlet temperature of the coolant fluid (e.g., at the edge 412 of the first layer 302) is from about 40° C. to about 90° C., from about 50° C. to about 80° C., about 60° C., or about 70° C. In some embodiments, the inlet pressure of the coolant fluid (e.g., at the opening 420) is from about 100 kiloPascal (kPa) to about 200 kPa, from about 110 kPa to about 190 kPa, from about 120 kPa to about 180 kPa, from about 130 kPa to about 170 kPa, or from about 140 kPa to about 160 kPa. In some embodiments, the outlet pressure of the coolant fluid (e.g., at the edge 412 of the first layer 302) is from about 80 kPa to about 180 kPa, from about 100 kPa to about 170 kPa, or from about 120 kPa to about 150 kPa. For example, the difference between the inlet and outlet pressure of the coolant fluid may be about 5 kPa, about 8 kPa, 10 kPa, about 15 kPa, about 20 kPa, or about 50 kPa.

### Numbered Paragraphs

Paragraph 1. An article comprising:
(i) a first layer comprising a material with high thermal conductivity, the first layer comprising a first surface and a second surface opposite the first surface;
(ii) a second layer comprising lithium, the second layer being supported by the first surface of the first layer; and
(iii) a support structure comprising one or more materials different from the material of the first layer, the support structure comprising one or more first channels adjacent to the second surface of the first layer, wherein each of the one or more first channels defines a continuous fluid path from a center to the second surface of the first layer to an edge of the first layer.

Paragraph 2. The article of paragraph 1, which is a neutron generation target.

Paragraph 3. The article of paragraph 1 or paragraph 2, wherein the weight of the article is from about 500 gram (g) to about 1,000 g.

Paragraph 4. The article of any one of paragraphs 1-3, wherein the article has a circular shape and the diameter of the article is from about 5 centimeters (cm) to about 20 cm.

Paragraph 5. The article of paragraph 4, wherein the diameter is about 10 cm.

Paragraph 6. The article of any one of paragraphs 1-5, wherein thermal conductivity of the material of the first layer is from about 300 W×m⁻¹×K⁻¹ to about 1000 W×m⁻¹×K⁻¹.

Paragraph 7. The article of any one of paragraphs 1-6, wherein the material with high thermal conductivity is selected from copper, gold, diamond, and copper-diamond composites.

Paragraph 8. The article of paragraph 7, wherein the material with high thermal conductivity is copper.

Paragraph 9. The article of any one of paragraphs 1-8, wherein a thickness of the first layer is from about 1 millimeter (mm) to about 12 mm.

Paragraph 10. The article of paragraph 9, wherein the thickness is selected from about 2 mm, about 3 mm, about 4 mm, about 5 mm, about 8 mm, or about 10 mm.

Paragraph 11. The article of any one of paragraphs 1-10, wherein the first layer is about 2 times, about 5 times, about 10 times, about 20 times, about 50 times, about 60 times, about 70 times, about 80 times, about 90 times, or about 100 times thicker than the second layer.

Paragraph 12. The article of any one of paragraphs 1-11, wherein the second layer comprises from about 92 percent by weight (wt. %) to about 98 wt. % of Li⁷ isotope.

Paragraph 13. The article of any one of paragraphs 1-12, wherein a thickness of the second layer is from about 15 micrometers (μm) to about 180 μm.

Paragraph 14. The article of paragraph 13, wherein the thickness of the second layer is from about 90 μm to about 100 μm.

Paragraph 15. The article of any one of paragraphs 1-14, wherein the second layer is supported by the first surface of the first layer by being bonded to the first layer through metallic bonds, electrostatic interactions, intermaterial diffusion, or any combination thereof.

Paragraph 16. The article of any one of paragraphs 1-15, wherein a thickness of the support structure is from about 10 mm to about 25 mm.

Paragraph 17. The article of any one of paragraphs 1-16, wherein thermal conductivity of the material different from the material of the first layer is from about 50 W×m⁻¹×K⁻¹ to about 300 W×m⁻¹×K⁻¹.

Paragraph 18. The article of any one of paragraphs 1-17, wherein the material different from the material of the first layer is selected from aluminum, titanium, magnesium, zinc, tungsten, nickel, cobalt, vanadium, and tin, or any combination thereof.

Paragraph 19. The article of any one of paragraphs 1-17, wherein the material different from the material of the first layer is aluminum.

Paragraph 20. The article of any one of paragraphs 1-17, wherein the material different from the material of the first layer is titanium.

Paragraph 21. The article of any one of paragraphs 1-20, wherein the support structure is bonded to the first layer through metallic bonds, electrostatic interactions, intermaterial diffusion, or any combination thereof.

Paragraph 22. The article of any one of paragraphs 1-21, wherein each of the one or more first channels has a house-shaped vertical cross-section.

Paragraph 23. The article of paragraph 22, wherein a foundation of the house-shaped vertical cross-section comprises the second surface of the first layer.

Paragraph 24. The article of paragraph 22 or paragraph 23, wherein the house-shaped vertical cross-section comprises a portion that tapers to an apex with increasing distance from the second surface of the first layer.

Paragraph 25. The article of any one of paragraphs 1-24, comprising two or more adjacent first channels separated by a wall formed from the one or more materials forming the support structure.

Paragraph 26. The article of paragraph 25, wherein a thickness of the wall if from about from about 0.1 mm to about 5 mm.

Paragraph 27. The article of paragraph 26, wherein the thickness of the wall is about 1 mm, about 2 mm, about 3 mm, about 4 mm, or about 5 mm.

Paragraph 28. The article of any one of paragraphs 25-27, wherein the thickness of the wall varies depending on a distance from the second surface of the first layer.

Paragraph 29. The article of any one of paragraphs 1-28, wherein the continuous fluid path is a spiral path from the center of the second surface to the edge of the first layer.

Paragraph 30. The article of any one of paragraphs 1-29, wherein the support structure comprises four adjacent first channels where each pair of said first channels is separated by a wall formed from the one or more materials forming the support structure, and each channel defines a corresponding spiral fluid path between the center of the second surface and the edge of the first layer.

Paragraph 31. The article of any one of paragraphs 1-30, wherein the support structure comprises one or more second channels distant from the second surface of the first layer and the one or more of the first channels, wherein each of the one or more second channels define a continuous fluid path from an edge of the support structure to the center of the support structure, and wherein the one or more second channels are fluidically connected with the one or more of the first channels at or near the center of the second surface of the first layer, thereby allowing a continuous fluid flow from the edge of the support structure through the one or more second channels and the one or more first channels to the edge of the first layer.

Paragraph 32. The article of paragraph 31, wherein the one or more of the second channels has a tear-drop shaped vertical cross-section.

Paragraph 33. A combination for manufacturing a radiation target, the combination comprising:
(a) a first layer comprising a material with high thermal conductivity, the first layer comprising a first surface and a second surface opposite the first surface; and
(b) a support structure comprising one or more materials different from the first layer, the support structure comprising one or more first channels adjacent to the second surface of the first layer, wherein each of the one or more first channels defines a continuous fluid path from a center to the second surface of the first layer to an edge of the first layer.

Paragraph 34. The combination of paragraph 33, wherein the weight of the combination is from about 500 gram (g) to about 1,000 g.

Paragraph 35. The combination of paragraph 33 or paragraph 34, wherein the combination has a circular shape and the diameter of the combination is from about 5 centimeters (cm) to about 20 cm.

Paragraph 36. The combination of paragraph 35, wherein the diameter is about 10 cm.

Paragraph 37. The combination of any one of paragraphs 33-36, wherein thermal conductivity of the material of the first layer is from about 300 W×m⁻¹×K⁻¹ to about 1000 W×m⁻¹×K⁻¹.

Paragraph 38. The combination of any one of paragraphs 33-37, wherein the material with high thermal conductivity is selected from copper, gold, diamond, and copper-diamond composites.

Paragraph 39. The combination of paragraph 38, wherein the material with high thermal conductivity is copper.

Paragraph 40. The combination of any one of paragraphs 33-39, wherein a thickness of the first layer is from about 1 millimeter (mm) to about 12 mm.

Paragraph 41. The combination of paragraph 40, wherein the thickness is selected from about 2 mm, about 3 mm, about 4 mm, about 5 mm, about 8 mm, or about 10 mm.

Paragraph 42. The combination of any one of paragraphs 33-41, wherein a thickness of the support structure is from about 10 mm to about 25 mm.

Paragraph 43. The combination of any one of paragraphs 33-42, wherein thermal conductivity of the material different from the material of the first layer is from about 50 W×m⁻¹×K⁻¹ to about 300 W×m⁻¹×K⁻¹.

Paragraph 44. The combination of any one of paragraphs 33-43, wherein the material different from the material of the first layer is selected from aluminum, titanium, magnesium, zinc, tungsten, nickel, cobalt, vanadium, and tin, or any combination thereof.

Paragraph 45. The combination of any one of paragraphs 33-43, wherein the material different from the material of the first layer is aluminum.

Paragraph 46. The combination of any one of paragraphs 33-43, wherein the material different from the material of the first layer is titanium.

Paragraph 47. The combination of any one of paragraphs 33-46, wherein the support structure is bonded to the first layer through metallic bonds, electrostatic interactions, intermaterial diffusion, or any combination thereof.

Paragraph 48. The combination of any one of paragraphs 33-47, wherein each of the one or more first channels has a house-shaped vertical cross-section.

Paragraph 49. The combination of paragraph 48, wherein a foundation of the house-shaped vertical cross-section comprises the second surface of the first layer.

Paragraph 50. The combination of paragraph 48 or paragraph 49, wherein the house-shaped vertical cross-section comprises a portion that tapers to an apex with increasing distance from the second surface of the first layer.

Paragraph 51. The combination of any one of any one of paragraphs 33-50, comprising two or more adjacent first channels separated by a wall formed from the one or more materials forming the support structure.

Paragraph 52. The combination of paragraph 51, wherein a thickness of the wall if from about from about 0.1 mm to about 5 mm.

Paragraph 53. The combination of paragraph 52, wherein the thickness of the wall is about 1 mm, about 2 mm, about 3 mm, about 4 mm, or about 5 mm.

Paragraph 54. The combination of any one of paragraphs 51-53, wherein the thickness of the wall varies depending on a distance from the second surface of the first layer.

Paragraph 55. The combination of any one of paragraphs 33-54, wherein the continuous fluid path is a spiral path from the center of the second surface to the edge of the first layer.

Paragraph 56. The combination of any one of paragraphs 33-55, wherein the support structure comprises four adjacent first channels where each pair of said first channels is separated by a wall formed from the one or more materials forming the support structure, and each channel defines a corresponding spiral fluid path between the center of the second surface and the edge of the first layer.

Paragraph 57. The combination of any one of paragraphs 33-56, wherein the support structure comprises one or more second channels distant from the second surface of the first layer and the one or more of the first channels, wherein each of the one or more second channels define a continuous fluid path from an edge of the support structure to the center of the support structure, and wherein the one or more second channels are fluidically connected with the one or more of the first channels at or near the center of the second surface of the first layer, thereby allowing a continuous fluid flow from the edge of the support structure through the one or more second channels and the one or more first channels to the edge of the first layer.

Paragraph 58. The combination of paragraph 57, wherein the one or more of the second channels has a tear-drop shaped vertical cross-section.

Paragraph 59. A method of making a combination for manufacturing a radiation target, the method comprising:
(i) obtaining a first layer made from a material with high thermal conductivity, the first layer having a first surface and a second surface opposite the first surface;
(ii) obtaining a support structure made from one or more materials different from the first layer, the support structure including one or more first channels, wherein each of the one or more first channels defines a continuous fluid path from a center to an edge of the support structure; and
(iii) contacting a side of the support structure that includes the one or more first channels with the second surface of the first layer to obtain a combination of the support structure and the first layer, wherein the support structure in the combination includes one or more first channels adjacent to the second surface of the first layer and each of the one or more first channels defines a continuous fluid path from a center to the second surface of the first layer to an edge of the first layer.

Paragraph 60. The method of paragraph 59, wherein the weight of the combination is from about 500 gram (g) to about 1,000 g.

Paragraph 61. The method of paragraph 59 or paragraph 60, wherein the combination has a circular shape and the diameter of the combination is from about 5 centimeters (cm) to about 20 cm.

Paragraph 62. The method of paragraph 61, wherein the diameter is about 10 cm.

Paragraph 63. The method of any one of paragraphs 59-62, wherein thermal conductivity of the material of the first layer is from about 300 W×m⁻¹×K⁻¹ to about 1000 W×m⁻¹×K⁻¹.

Paragraph 64. The method of any one of paragraphs 59-63, wherein the material with high thermal conductivity is selected from copper, gold, diamond, and copper-diamond composites.

Paragraph 65. The method of paragraph 64, wherein the material with high thermal conductivity is copper.

Paragraph 66. The method of any one of paragraphs 59-65, wherein a thickness of the first layer is from about 1 millimeter (mm) to about 12 mm.

Paragraph 67. The method of paragraph 66, wherein the thickness is selected from about 2 mm, about 3 mm, about 4 mm, about 5 mm, about 8 mm, or about 10 mm.

Paragraph 68. The method of any one of paragraphs 59-67, wherein the first layer is about 2 times, about 5 times, about 10 times, about 20 times, about 50 times, about 60 times, about 70 times, about 80 times, about 90 times, or about 100 times thicker than the second layer.

Paragraph 69. The method of any one of paragraphs 59-68, wherein thermal conductivity of the material different from the material of the first layer is from about 50 W×m⁻¹×K⁻¹ to about 300 W×m⁻¹×K⁻¹.

Paragraph 70. The method of any one of paragraphs 59-69, wherein the material different from the material of the first layer is selected from aluminum, titanium, magnesium, zinc, tungsten, nickel, cobalt, vanadium, and tin, or any combination thereof.

Paragraph 71. The method of any one of paragraphs 59-69, wherein the material different from the material of the first layer is aluminum.

Paragraph 72. The method of any one of paragraphs 59-69, wherein the material different from the material of the first layer is titanium.

Paragraph 73. The method of any one of paragraphs 59-72, wherein the contacting comprises bonding the first layer to the support structure to obtain the combination.

Paragraph 74. The method of paragraph 73, wherein the bonding comprises metallic bonds, electrostatic interactions, intermaterial diffusion, or any combination thereof.

Paragraph 75. The method of any one of paragraphs 59-74, wherein each of the one or more first channels in the combination has a house-shaped vertical cross-section.

Paragraph 76. The method of paragraph 75, wherein a foundation of the house-shaped vertical cross-section comprises the second surface of the first layer.

Paragraph 77. The method of any one of paragraphs 59-76, comprising two or more adjacent first channels separated by a wall formed from the one or more materials forming the support structure.

Paragraph 78. The method of paragraph 77, wherein a thickness of the wall if from about from about 0.1 mm to about 5 mm.

Paragraph 79. The method of paragraph 78, wherein the thickness of the wall is about 1 mm, about 2 mm, about 3 mm, about 4 mm, or about 5 mm.

Paragraph 80. The method of any one of paragraphs 77-79, wherein the thickness of the wall varies depending on a distance from the second surface of the first layer.

Paragraph 81. The method of any one of paragraphs 59-80, wherein the continuous fluid path in the combination is a spiral path from the center of the second surface to the edge of the first layer.

Paragraph 82. The method of any one of paragraphs 59-81, wherein the support structure comprises four adjacent first channels where each pair of said first channels is separated by a wall formed from the one or more materials forming the support structure, and each channel defines a corresponding spiral fluid path between the center of the second surface and the edge of the first layer.

Paragraph 83. The method of any one of paragraphs 59-82, wherein the support structure comprises one or more second channels distant from the second surface of the first layer and the one or more of the first channels, wherein each of the one or more second channels define a continuous fluid path from an edge of the support structure to the center of the support structure, and wherein the one or more second channels are fluidically connected with the one or more of the first channels at or near the center of the second surface of the first layer, thereby allowing a continuous fluid flow from the edge of the support structure through the one or more second channels and the one or more first channels to the edge of the first layer.

Paragraph 84. The method of paragraph 83, wherein the one or more of the second channels has a tear-drop shaped vertical cross-section.

Paragraph 85. The method of any one of paragraphs 59-84, wherein the contacting comprises brazing, welding, or soldering, or any combination thereof.

Paragraph 86. The method of any one of paragraphs 59-84, wherein the contacting comprises applying a mechanical force to the first layer or the support structure, or both, to obtain the combination.

Paragraph 87. The method of paragraph 86, wherein the mechanical force is from about 1 megaPascal (MPa) to about 3 MPa.

Paragraph 88. The method of paragraph 86 or 87, comprising heating the first layer, the support structure, or both, to facilitate the bonding of the first layer to the support structure to obtain the combination.

Paragraph 89. The method of paragraph 88, wherein the heating comprises a temperature from about 400 degrees Celsius (° C.) to about 1000° C.

Paragraph 90. A system for making a combination for manufacturing a radiation target, the combination comprising:
(i) a first layer comprising a material with high thermal conductivity, the first layer comprising a first surface and a second surface opposite the first surface;
(ii) a support structure comprising one or more materials different from the first layer, the support structure comprising one or more first channels adjacent to the second surface of the first layer, wherein each of the one or more first channels defines a continuous fluid path from a center to the second surface of the first layer to an edge of the first layer;
the system comprising:
(i) a three-dimensional printer device configured to receive and store (a) the material with high thermal conductivity for making the first layer and (b) the one or more materials different from the material of the first layer for making the support structure; and configured to prepare the combination; and
(ii) a controller associated with the three-dimensional printer device, the controller comprising: a processor; a memory; and a computer instruction stored in the memory and executable by the processor, the controller configured to instructing the three-dimensional printer to prepare the combination from (a) the material with high thermal conductivity for making the first layer and (b) the one or more materials different from the material of the first layer for making the support structure.

Paragraph 91. The system of paragraph 90, wherein the weight of the combination is from about 500 gram (g) to about 1,000 g.

Paragraph 92. The system of paragraph 90 or paragraph 91, wherein the combination has a circular shape and the diameter of the combination is from about 5 centimeters (cm) to about 20 cm.

Paragraph 93. The system of paragraph 92, wherein the diameter is about 10 cm.

Paragraph 94. The system of any one of paragraphs 90-93, wherein thermal conductivity of the material of the first layer is from about 300 W×m⁻¹×K⁻¹ to about 1000 W×m⁻¹×K⁻¹.

Paragraph 95. The system of any one of paragraphs 90-93, wherein the material with high thermal conductivity is selected from copper, gold, diamond, and copper-diamond composites.

Paragraph 96. The system of paragraph 95, wherein the material with high thermal conductivity is copper.

Paragraph 97. The system of any one of paragraphs 90-96, wherein a thickness of the first layer is from about 1 millimeter (mm) to about 12 mm.

Paragraph 98. The system of paragraph 97, wherein the thickness is selected from about 2 mm, about 3 mm, about 4 mm, about 5 mm, about 8 mm, or about 10 mm.

Paragraph 99. The system of any one of paragraphs 90-98, wherein a thickness of the support structure is from about 10 mm to about 25 mm.

Paragraph 100. The system of any one of paragraphs 90-99, wherein thermal conductivity of the material different from the material of the first layer is from about 50 W×m⁻¹×K⁻¹ to about 300 W×m⁻¹×K⁻¹.

Paragraph 101. The system of any one of paragraphs 90-100, wherein the material different from the material of the first layer is selected from aluminum, titanium, magnesium, zinc, tungsten, nickel, cobalt, vanadium, and tin, or any combination thereof.

Paragraph 102. The system of any one of paragraphs 90-100, wherein the material different from the material of the first layer is aluminum.

Paragraph 103. The system of any one of paragraphs 90-100, wherein the material different from the material of the first layer is aluminum.

Paragraph 104. The system of any one of paragraphs 90-100, wherein the material different from the material of the first layer is titanium.

Paragraph 105. The system of any one of paragraphs 90-104, wherein the support structure is bonded to the first layer through metallic bonds, electrostatic interactions, intermaterial diffusion, or any combination thereof.

Paragraph 106. The system of any one of paragraphs 90-105, wherein each of the one or more first channels in the combination has a house-shaped vertical cross-section.

Paragraph 107. The system of paragraph 106, wherein a foundation of the house-shaped vertical cross-section comprises the second surface of the first layer.

Paragraph 108. The system of paragraph 106 or 107, wherein the house-shaped vertical cross-section comprises a portion that tapers to an apex with increasing distance from the second surface of the first layer.

Paragraph 109. The system of any one of paragraphs 90-108, wherein the combination comprises two or more adjacent first channels separated by a wall formed from the one or more materials forming the support structure.

Paragraph 110. The system of paragraph 109, wherein a thickness of the wall if from about from about 0.1 mm to about 5 mm.

Paragraph 111. The system of paragraph 110, wherein the thickness of the wall is about 1 mm, about 2 mm, about 3 mm, about 4 mm, or about 5 mm.

Paragraph 112. The system of any one of paragraphs 109-111, wherein the thickness of the wall varies depending on a distance from the second surface of the first layer.

Paragraph 113. The system of any one of paragraphs 90-112, wherein the continuous fluid path in the support structure of the combination is a spiral path from the center of the second surface to the edge of the first layer.

Paragraph 114. The system of any one of paragraphs 90-113, wherein the support structure comprises four adjacent first channels where each pair of said first channels is separated by a wall formed from the one or more materials forming the support structure, and each channel defines a corresponding spiral fluid path between the center of the second surface and the edge of the first layer.

Paragraph 115. The system of any one of paragraphs 90-114, wherein the support structure comprises one or more second channels distant from the second surface of the first layer and the one or more of the first channels, wherein each of the one or more second channels define a continuous fluid path from an edge of the support structure to the center of the support structure, and wherein the one or more second channels are fluidically connected with the one or more of the first channels at or near the center of the second surface of the first layer, thereby allowing a continuous fluid flow from the edge of the support structure through the one or more second channels and the one or more first channels to the edge of the first layer.

Paragraph 116. The system of paragraph 115, wherein the one or more of the second channels has a tear-drop shaped vertical cross-section.

Paragraph 117. The system of any one of paragraphs 90-116, wherein the three-dimensional printer device is selected from a fused deposition modeling printer, a stereolithography printer, a digital light processing printer, a selective laser sintering printer, a selective laser melting printer, a laminated object manufacturing printer, a digital beam melting printer, or any combination thereof.

Paragraph 118. A method of making an article for irradiation, the article comprising:
(i) a first layer comprising a material with high thermal conductivity, the first layer comprising a first surface and a second surface opposite the first surface;
(ii) a second layer comprising lithium, the second layer being supported by the first surface of the first layer; and
(iii) a support structure comprising one or more materials different from the material of the first layer, the support structure comprising one or more first channels adjacent to the second surface of the first layer, wherein each of the one or more first channels defines a continuous fluid path from a center to the second surface of the first layer to an edge of the first layer, the method comprising contacting the first surface of the first layer of a combination comprising the support structure and the first layer with a material comprising lithium, to obtain the article.

Paragraph 119. The method of paragraph 118, wherein the article is a neutron generation target.

Paragraph 120. The method of paragraph 118 or paragraph 119, wherein the weight of the article is from about 500 gram (g) to about 1,000 g.

Paragraph 121. The method of any one of paragraphs 118-120, wherein the article has a circular shape and the diameter of the article is from about 5 centimeters (cm) to about 20 cm.

Paragraph 122. The method of paragraph 121, wherein the diameter is about 10 cm.

Paragraph 123. The method of any one of paragraphs 118-122, wherein thermal conductivity of the material of the first layer is from about 300 W×m⁻¹×K⁻¹ to about 1000 W×m⁻¹×K⁻¹.

Paragraph 124. The method of any one of paragraphs 118-123, wherein the material with high thermal conductivity is selected from copper, gold, diamond, and copper-diamond composites.

Paragraph 125. The method of paragraph 124, wherein the material with high thermal conductivity is copper.

Paragraph 126. The method of any one of paragraphs 118-125, wherein a thickness of the first layer is from about 1 millimeter (mm) to about 12 mm.

Paragraph 127. The method of paragraph 126, wherein the thickness is selected from about 2 mm, about 3 mm, about 4 mm, about 5 mm, about 8 mm, or about 10 mm.

Paragraph 128. The method of any one of paragraphs 118-127, wherein the first layer is about 2 times, about 5 times, about 10 times, about 20 times, about 50 times, about 60 times, about 70 times, about 80 times, about 90 times, or about 100 times thicker than the second layer.

Paragraph 129. The method of any one of paragraphs 118-128, wherein the second layer comprises from about 92 percent by weight (wt. %) to about 98 wt. % of Li⁷ isotope.

Paragraph 130. The method of any one of paragraphs 118-129, wherein a thickness of the second layer is from about 15 micrometers (μm) to about 180 μm.

Paragraph 131. The method of paragraph 130, wherein the thickness of the second layer is from about 90 μm to about 100 μm.

Paragraph 132. The method of any one of paragraphs 118-131, wherein the second layer is supported by the first surface of the first layer by being bonded to the first layer through metallic bonds, electrostatic interactions, intermaterial diffusion, or any combination thereof.

Paragraph 133. The method of any one of paragraphs 118-132, wherein a thickness of the support structure is from about 10 mm to about 25 mm.

Paragraph 134. The method of any one of paragraphs 118-133, wherein thermal conductivity of the material different from the material of the first layer is from about 50 W×m⁻¹×K⁻¹ to about 300 W×m⁻¹×K⁻¹.

Paragraph 135. The method of any one of paragraphs 118-134, wherein the material different from the material of the first layer is selected from aluminum, titanium, magnesium, zinc, tungsten, nickel, cobalt, vanadium, and tin, or any combination thereof.

Paragraph 136. The method of any one of paragraphs 118-134, wherein the material different from the material of the first layer is aluminum.

Paragraph 137. The method of any one of paragraphs 118-134, wherein the material different from the material of the first layer is titanium.

Paragraph 138. The method of any one of paragraphs 118-137, wherein the support structure is bonded to the first layer through metallic bonds, electrostatic interactions, intermaterial diffusion, or any combination thereof.

Paragraph 139. The method of any one of paragraphs 118-138, wherein each of the one or more first channels has a house-shaped vertical cross-section.

Paragraph 140. The method of paragraph 139, wherein a foundation of the house-shaped vertical cross-section comprises the second surface of the first layer.

Paragraph 141. The method of paragraph 139 or paragraph 140, wherein the house-shaped vertical cross-section comprises a portion that tapers to an apex with increasing distance from the second surface of the first layer.

Paragraph 142. The method of any one of paragraph 118-141, wherein the article comprises two or more adjacent first channels separated by a wall formed from the one or more materials forming the support structure.

Paragraph 143. The method of paragraph 142, wherein a thickness of the wall if from about from about 0.1 mm to about 5 mm.

Paragraph 144. The method of paragraph 143, wherein the thickness of the wall is about 1 mm, about 2 mm, about 3 mm, about 4 mm, or about 5 mm.

Paragraph 145. The method of any one of paragraphs 142-144, wherein the thickness of the wall varies depending on a distance from the second surface of the first layer.

Paragraph 146. The method of any one of paragraphs 118-145, wherein the support structure comprises four adjacent first channels where each pair of said first channels is separated by a wall formed from the one or more materials forming the support structure, and each channel defines a corresponding spiral fluid path between the center of the second surface and the edge of the first layer.

Paragraph 147. The method of any one of paragraphs 118-146, wherein the support structure comprises one or more second channels distant from the second surface of the first layer and the one or more of the first channels, wherein each of the one or more second channels define a continuous fluid path from an edge of the support structure to the center of the support structure, and wherein the one or more second channels are fluidically connected with the one or more of the first channels at or near the center of the second surface of the first layer, thereby allowing a continuous fluid flow from the edge of the support structure through the one or more second channels and the one or more first channels to the edge of the first layer.

Paragraph 148. The method of paragraph 147, wherein the one or more of the second channels has a tear-drop shaped vertical cross-section.

Paragraph 149. The method of any one of paragraphs 118-148, the method comprising obtaining a combination comprising:
(a) a first layer comprising a material with high thermal conductivity, the first layer comprising a first surface and a second surface opposite the first surface;
(b) a support structure comprising one or more materials different from the material of the first layer, the support structure comprising one or more first channels adjacent to the second surface of the first layer, wherein each of the one or more first channels defines a continuous fluid path from a center to the second surface of the first layer to an edge of the first layer, before contacting the first surface of the first layer with the material comprising lithium.

Paragraph 150. The method of any one of paragraphs 118-149, wherein the contacting is carried by a vacuum deposition technique.

Paragraph 151. The method of any one of paragraphs 118-149, wherein the contacting is carried out by applying a lithium foil to the first surface of the first layer followed by applying a mechanical force to the lithium foil to form the second layer.

Paragraph 152. The method of paragraph 151, wherein the mechanical force is from about 1 megaPascal (MPa) to about 3 MPa.

Paragraph 153. The method of any one of paragraphs 118-152, wherein material comprising lithium is bonded to the first layer during contacting to form the second layer.

Paragraph 154. A system for making an article for irradiation, the article comprising:
(i) a first layer comprising a material with high thermal conductivity, the first layer comprising a first surface and a second surface opposite the first surface;
(ii) a second layer comprising lithium, the second layer being supported by the first surface of the first layer; and
(iii) a support structure comprising one or more materials different from the first layer, the support structure comprising one or more first channels adjacent to the second surface of the first layer, wherein each of the one or more first channels defines a continuous fluid path from a center to the second surface of the first layer to an edge of the first layer; the system comprising:
(i) a three-dimensional printer device configured to receive and store (a) the material with high thermal conductivity for making the first layer, (b) the one or more materials different from the material of the first layer for making the support structure, and (c) a material comprising lithium for making the second layer; and configured to prepare the article; and
(ii) a controller associated with the three-dimensional printer device, the controller comprising: a processor; a memory; and a computer instruction stored in the memory and executable by the processor, the controller configured to instructing the three-dimensional printer to prepare the article from (a) the material with high thermal conductivity for making the first layer, (b) the one or more materials different from the material of the first layer for making the support structure, and (c) the material comprising lithium for making the second layer.

Paragraph 155. The system of paragraph 154, wherein the article is a neutron generation target.

Paragraph 156. The system of paragraph 154 or paragraph 155, wherein the weight of the article is from about 500 gram (g) to about 1,000 g.

Paragraph 157. The system of any one of paragraphs 154-156, wherein the article has a circular shape and the diameter of the article is from about 5 centimeters (cm) to about 20 cm.

Paragraph 158. The system of paragraph 157, wherein the diameter is about 10 cm.

Paragraph 159. The system of any one of paragraphs 154-158, wherein thermal conductivity of the material of the first layer is from about 300 W×m⁻¹×K⁻¹ to about 1000 W×m⁻¹×K⁻¹.

Paragraph 160. The system of any one of paragraphs 154-159, wherein the material with high thermal conductivity is selected from copper, gold, diamond, and copper-diamond composites.

Paragraph 161. The system of paragraph 160, wherein the material with high thermal conductivity is copper.

Paragraph 162. The system of any one of paragraphs 154-161, wherein a thickness of the first layer is from about 1 millimeter (mm) to about 12 mm.

Paragraph 163. The system of paragraph 162, wherein the thickness is selected from about 2 mm, about 3 mm, about 4 mm, about 5 mm, about 8 mm, or about 10 mm.

Paragraph 164. The system of any one of paragraphs 154-163, wherein the first layer is about 2 times, about 5 times, about 10 times, about 20 times, about 50 times, about 60 times, about 70 times, about 80 times, about 90 times, or about 100 times thicker than the second layer.

Paragraph 165. The system of any one of paragraphs 154-164, wherein the second layer comprises from about 92 percent by weight (wt. %) to about 98 wt. % of Li⁷ isotope.

Paragraph 166. The system of any one of paragraphs 154-165, wherein a thickness of the second layer is from about 15 micrometers (μm) to about 180 μm.

Paragraph 167. The system of paragraph 166, wherein the thickness of the second layer is from about 90 μm to about 100 μm.

Paragraph 168. The system of any one of paragraphs 154-167, wherein the second layer is supported by the first surface of the first layer by being bonded to the first layer through metallic bonds, electrostatic interactions, intermaterial diffusion, or any combination thereof.

Paragraph 169. The system of any one of paragraphs 154-168, wherein a thickness of the support structure is from about 10 mm to about 25 mm.

Paragraph 170. The system of any one of paragraphs 154-169, wherein thermal conductivity of the material different from the material of the first layer is from about 50 W×m⁻¹×K⁻¹ to about 300 W×m⁻¹×K⁻¹.

Paragraph 171. The system of any one of paragraphs 154-170, wherein the material different from the material of the first layer is selected from aluminum, titanium, magnesium, zinc, tungsten, nickel, cobalt, vanadium, and tin, or any combination thereof.

Paragraph 172. The system of any one of paragraphs 154-170, wherein the material different from the material of the first layer is aluminum.

Paragraph 173. The system of any one of paragraphs 154-170, wherein the material different from the material of the first layer is titanium.

Paragraph 174. The system of any one of paragraphs 154-173, wherein the support structure is bonded to the first layer through metallic bonds, electrostatic interactions, intermaterial diffusion, or any combination thereof.

Paragraph 175. The system of any one of paragraphs 154-174, wherein each of the one or more first channels has a house-shaped vertical cross-section.

Paragraph 176. The system of paragraph 175, wherein a foundation of the house-shaped vertical cross-section comprises the second surface of the first layer.

Paragraph 177. The system of paragraph 175 or paragraph 176, wherein the house-shaped vertical cross-section comprises a portion that tapers to an apex with increasing distance from the second surface of the first layer.

Paragraph 178. The system of any one of paragraphs 154-177, wherein the article comprises two or more adjacent first channels separated by a wall formed from the one or more materials forming the support structure.

Paragraph 179. The system of paragraph 178, wherein a thickness of the wall if from about from about 0.1 mm to about 5 mm.

Paragraph 180. The system of paragraph 179, wherein the thickness of the wall is about 1 mm, about 2 mm, about 3 mm, about 4 mm, or about 5 mm.

Paragraph 181. The system of any one of paragraphs 178-180, wherein the thickness of the wall varies depending on a distance from the second surface of the first layer.

Paragraph 182. The system of any one of paragraphs 154-181, wherein the continuous fluid path is a spiral path from the center of the second surface to the edge of the first layer.

Paragraph 183. The system of any one of paragraphs 154-182, wherein the support structure comprises one or more second channels distant from the second surface of the first layer and the one or more of the first channels, wherein each of the one or more second channels define a continuous fluid path from an edge of the support structure to the center of the support structure, and wherein the one or more second channels are fluidically connected with the one or more of the first channels at or near the center of the second surface of the first layer, thereby allowing a continuous fluid flow from the edge of the support structure through the one or more second channels and the one or more first channels to the edge of the first layer.

Paragraph 184. The system of paragraph 183, wherein the one or more of the second channels has a tear-drop shaped vertical cross-section.

Paragraph 185. The system of any one of paragraphs 154-184, wherein the three-dimensional printer device is selected from a fused deposition modeling printer, a stereolithography printer, a digital light processing printer, a selective laser sintering printer, a selective laser melting printer, a laminated object manufacturing printer, a digital beam melting printer, or any combination thereof.

Paragraph 186. A method of treating a cancer in a subject in need thereof, the method comprising
(i) administering to the subject a therapeutically effective amount of a compound comprising B¹⁰,
(ii) waiting a sufficient amount of time for the compound comprising B¹⁰ to accumulate in a cancer tissue within the subject,
(iii) contacting an article of any one of paragraphs 1-32 with a beam of protons to produce a beam of neutrons, and
(iv) directing the beam of neutrons to the cancer tissue.

Paragraph 187. The method of paragraph 186, wherein the cancer is selected from liver cancer, oral cancer, colon cancer, brain cancer, head and neck cancer, lung cancer, breast cancer, gastric cancer, extensive squamous cell carcinoma, laryngeal cancer, melanoma, sarcoma, and extramammary Paget's disease.

Paragraph 188. The method of paragraph 187, wherein the liver cancer is selected from hepatocellular carcinoma, intrahepatic cholangiocarcinoma, hepatoblastoma, and hepatic adenoma.

Paragraph 189. The method of paragraph 187, wherein the brain cancer is selected from glioblastoma, meningioma, and medulloblastoma.

Paragraph 190. The method of any one of paragraphs 186-189, wherein the cancer is a recurrent cancer.

Paragraph 191. The method of any one of paragraphs 186-189, wherein the cancer is a metastatic cancer.

Paragraph 192. The method of any one of paragraphs 186-191, wherein the therapeutic amount is from about 1 milligram (mg) to about 100 mg of B¹⁰ per one kilogram (kg) of the subject's body weight.

Paragraph 193. The method of any one of paragraphs 186-192, wherein the compound comprising B¹⁰ is selected from boronophenylalanine, borocaptate sodium, or 1-amino-3-boronocyclo-pentanecarboxylic acid.

Paragraph 194. The method of any one of paragraphs 186-193, wherein the compound comprising B¹⁰ accumulates in the cancer tissue at a level from about 20 to about 50 microgram (μg) of B¹⁰ per gram (g) of tumor.

Paragraph 195. The method of any one of paragraphs 186-194, wherein the sufficient amount of time is from about 30 sec to about 1 h.

Paragraph 196. The method of any one of paragraphs 186-195, wherein energy of the beam of protons is from about 2 MeV to about 3 MeV.

Paragraph 197. The method of any one of paragraphs 186-196, comprising cooling the article during contacting to maintain its operating temperature from about 130 degrees Celsius (° C.) to about 150° C.

Paragraph 198. The method of paragraph 197, wherein the cooling comprises flowing a coolant fluid through the one or more first channels adjacent to the second surface of the first layer thereby removing heat from the first layer.

Paragraph 199. The method of paragraph 198, wherein the coolant fluid is selected from water, an alcohol, an antifreeze, or a combination thereof.

Paragraph 200. The method of paragraph 198 wherein the coolant fluid is water.

Paragraph 201. The method of any one of paragraphs 198-200, wherein the coolant fluid is substantially degassed.

Paragraph 202. The method of any one of paragraphs 198-201, wherein a flow rate of the coolant fluid is from about 10 kilogram per minute (kg/min) to about 200 kg/min.

Paragraph 203. The method of any one of paragraphs 198-202, wherein the flowing comprises a laminar flow.

Paragraph 204. The method of any one of paragraphs 198-203, wherein an inlet temperature of the coolant fluid is from about 5° C. to about 30° C., and an outlet temperature of the coolant fluid is from about 40° C. to about 90° C.

Paragraph 205. The method of any one of paragraphs 198-204, wherein an inlet pressure of the coolant fluid is from about 100 kiloPascal (kPa) to about 200 kPa, and an outlet pressure of the coolant fluid is from about 80 kPa to about 180 kPa.

### OTHER EMBODIMENTS

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

1. An article comprising:
(i) a first layer comprising a material with high thermal conductivity, the first layer comprising a first surface and a second surface opposite the first surface;
(ii) a second layer comprising lithium, the second layer being supported by the first surface of the first layer; and
(iii) a support structure comprising one or more materials different from the material of the first layer, the support structure comprising one or more first channels adjacent to the second surface of the first layer, wherein each of the one or more first channels defines a continuous fluid path from a center to the second surface of the first layer to an edge of the first layer.

2. The article of claim 1, which is a neutron generation target.

3. The article of claim 1, wherein the weight of the article is from about 500 gram (g) to about 1,000 g.

4. The article of claim 1, wherein the article has a circular shape and the diameter of the article is from about 5 centimeters (cm) to about 20 cm.

5. The article of claim 4, wherein the diameter is about 10 cm.

6. The article of claim 1, wherein thermal conductivity of the material of the first layer is from about 300 W×m⁻¹×K⁻¹ to about 1000 W×m⁻¹×K⁻¹.

7. The article of claim 1, wherein the material with high thermal conductivity is selected from copper, gold, diamond, and copper-diamond composites.

8. The article of claim 7, wherein the material with high thermal conductivity is copper.

9. The article of claim 1, wherein a thickness of the first layer is from about 1 millimeter (mm) to about 12 mm.

10. The article of claim 9, wherein the thickness is selected from about 2 mm, about 3 mm, about 4 mm, about 5 mm, about 8 mm, or about 10 mm.

11. The article of claim 1, wherein the first layer is about 2 times, about 5 times, about 10 times, about 20 times, about 50 times, about 60 times, about 70 times, about 80 times, about 90 times, or about 100 times thicker than the second layer.

12. The article of claim 1, wherein the second layer comprises from about 92 percent by weight (wt. %) to about 98 wt. % of Li⁷ isotope.

13. The article of claim 1, wherein a thickness of the second layer is from about 15 micrometers (μm) to about 180 μm.

14. The article of claim 13, wherein the thickness of the second layer is from about 90 μm to about 100 μm.

15. The article of claim 1, wherein the second layer is supported by the first surface of the first layer by being bonded to the first layer through metallic bonds, electrostatic interactions, intermaterial diffusion, or any combination thereof.

16. The article of claim 1, wherein a thickness of the support structure is from about 10 mm to about 25 mm.

17. The article of claim 1, wherein thermal conductivity of the material different from the material of the first layer is from about 50 W×m⁻¹×K⁻¹ to about 300 W×m⁻¹×K⁻¹.

18. The article of claim 1, wherein the material different from the material of the first layer is selected from aluminum, titanium, magnesium, zinc, tungsten, nickel, cobalt, vanadium, and tin, or any combination thereof.

19-32. (canceled)

33. A combination for manufacturing a radiation target, the combination comprising:
(a) a first layer comprising a material with high thermal conductivity, the first layer comprising a first surface and a second surface opposite the first surface; and
(b) a support structure comprising one or more materials different from the first layer, the support structure comprising one or more first channels adjacent to the second surface of the first layer, wherein each of the one or more first channels defines a continuous fluid path from a center to the second surface of the first layer to an edge of the first layer.

34-58. (canceled)

59. A method of making a combination for manufacturing a radiation target, the method comprising:
(i) obtaining a first layer made from a material with high thermal conductivity, the first layer having a first surface and a second surface opposite the first surface;
(ii) obtaining a support structure made from one or more materials different from the first layer, the support structure including one or more first channels, wherein each of the one or more first channels defines a continuous fluid path from a center to an edge of the support structure; and
(iii) contacting a side of the support structure that includes the one or more first channels with the second surface of the first layer to obtain a combination of the support structure and the first layer, wherein the support structure in the combination includes one or more first channels adjacent to the second surface of the first layer and each of the one or more first channels defines a continuous fluid path from a center to the second surface of the first layer to an edge of the first layer.

60-205. (canceled)
